(19) United States
(12) Patent Application Publication
(10) Pub. No.: US 2015/0100155 A1
(43) Pub. Date: Apr. 9, 2015

(54) PROTOCOL GENERATION FOR LIQUID HANDLER

(71) Applicant: Gilson, Inc., Middleton, WI (US)

(72) Inventors: Matjaz Hren, Kocevje (SI); Luka Murn, Skofja Loka (SI); Urska Cepin, Ljubecna (SI); Klemen Zupancic, Ljubljana (SI)

(73) Assignee: Gilson, Inc., Middleton, WI (US)

(21) Appl. No.: 14/045,299

(22) Filed: Oct. 3, 2013

(51) Int. Cl. G05B 11/01

(52) U.S. Cl. CPC G05B 11/01
USPC 700/244

(57) ABSTRACT

A method of creating a protocol is provided. An interface window is presented on a display. A first indicator that identifies a sample and a second indicator that indicates selection of an analysis are received from the interface window. The analysis defines processing to be performed on the identified sample by a liquid handler. A bed layout that defines locations of a plurality of labware components and a type of labware component at each location on a work bed of the liquid handler is determined based on the first indicator and the second indicator. The sample is associated with a location of the locations. The determined bed layout is presented on the display. A protocol for execution by a controller of the liquid handler is created. The protocol comprises a second plurality of instructions configured to cause the liquid handler to perform the analysis on the identified sample.

### BACKGROUND

In pharmaceutical, genomic and proteomic research and drug development laboratories, as well as similar applications, automated liquid handlers are used for handling laboratory samples in a variety of laboratory procedures to prepare the samples for analysis. For example, liquid handlers are used for biotechnological and pharmaceutical liquid assay procedures, sample preparation, compound distribution, microarray manufacturing, qPCR experiments, liquid chromatography, etc. For illustration, automated liquid handlers are disclosed in U.S. Pat. Nos. 4,422,151; 5,988,236; 7,055,402; 7,288,228; 7,669,489; 7,874,324 assigned to the assignee of the present application and incorporated herein by reference.

In general, a liquid handler has a work bed that supports one or more sample holding receptacles, with one or more pipetting heads mounted to move over the work bed and to aspirate/dispense liquid from/into the sample receptacles. As understood by a person of skill in the art, disposable tips may be used on the one or more pipetting heads. A protocol is executed that includes instructions to automatically control the aspiration/dispensation of material into/out of the sample receptacles.

### SUMMARY

In an example embodiment, a method of creating a protocol is provided. A sample definition interface window is presented on a display. A first indicator that identifies a sample is received from the sample definition interface window. A second indicator is received from the sample definition interface window that indicates selection of an analysis. The analysis defines processing to be performed on the identified sample by a liquid handler. A bed layout for the liquid handler is determined based on the first indicator and the second indicator. The bed layout defines locations of a plurality of labware components and a type of labware component at each location on a work bed of the liquid handler to perform the analysis on the identified sample. The sample is associated with a location of the locations. The determined bed layout is presented on the display. A protocol for execution by a controller of the liquid handler is created. The protocol comprises a second plurality of instructions configured to cause the liquid handler to perform the analysis on the identified sample.

In another example embodiment, a computer-readable medium is provided having stored thereon computer-readable instructions that when executed by a computing device, cause the computing device to perform the method of creating a protocol.

In yet another example embodiment, a system is provided. The system includes, but is not limited to, a processor and a computer-readable medium operably coupled to the processor. The computer-readable medium has instructions stored thereon that, when executed by the processor, cause the system to perform the method of creating a protocol.

Other principal features of the disclosed subject matter will become apparent to those skilled in the art upon review of the following drawings, the detailed description, and the appended claims.

### BRIEF DESCRIPTION OF THE DRAWINGS

Illustrative embodiments of the disclosed subject matter will hereafter be described referring to the accompanying drawings, wherein like numerals denote like elements.

FIG. 1 depicts a block diagram of a liquid handling system in accordance with an illustrative embodiment.

FIG. 2 depicts a right, perspective view of a liquid handler in accordance with an illustrative embodiment.

FIG. 3 depicts a front view of the liquid handler of FIG. 2.

FIG. 4 depicts a top view of the liquid handler of FIG. 2 with protective covers removed.

FIG. 5 depicts a top, perspective view of a base and translating plate of the liquid handler of FIG. 2.

FIG. 6 depicts a block diagram of a controller of the liquid handler of FIG. 2 in accordance with an illustrative embodiment.

FIG. 7 depicts a block diagram of a protocol creation device of the liquid handling system of FIG. 1 in accordance with an illustrative embodiment.

FIG. 8 depicts a block diagram of a server of the liquid handling system of FIG. 1 in accordance with an illustrative embodiment.

FIG. 9 depicts a flow diagram illustrating examples of operations performed by the protocol creation device of FIG. 7 and/or the server of FIG. 8 in accordance with an illustrative embodiment.

FIG. 12 depicts a second flow diagram illustrating examples of operations performed by the protocol creation device of FIG. 7 and/or the server of FIG. 8 in accordance with an illustrative embodiment.

FIG. 14 depicts a third flow diagram illustrating examples of operations performed by the protocol creation device of FIG. 7 and/or the server of FIG. 8 in accordance with an illustrative embodiment.

FIG. 27 depicts a fourth flow diagram illustrating examples of operations performed by the protocol creation device of FIG. 7 and/or the server of FIG. 8 in accordance with an illustrative embodiment.

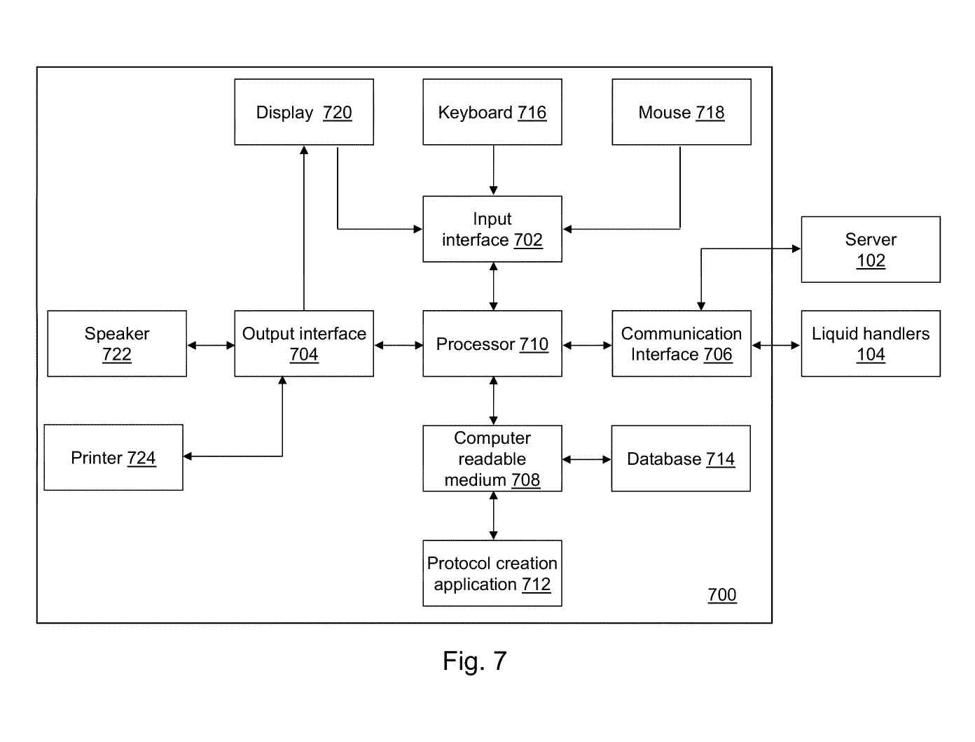

FIGS. 10, 11, 13, 15-26, and 28-36 depict user interface windows of the protocol creation application of FIGS. 7 and/or 8 in accordance with an illustrative embodiment.

### DETAILED DESCRIPTION

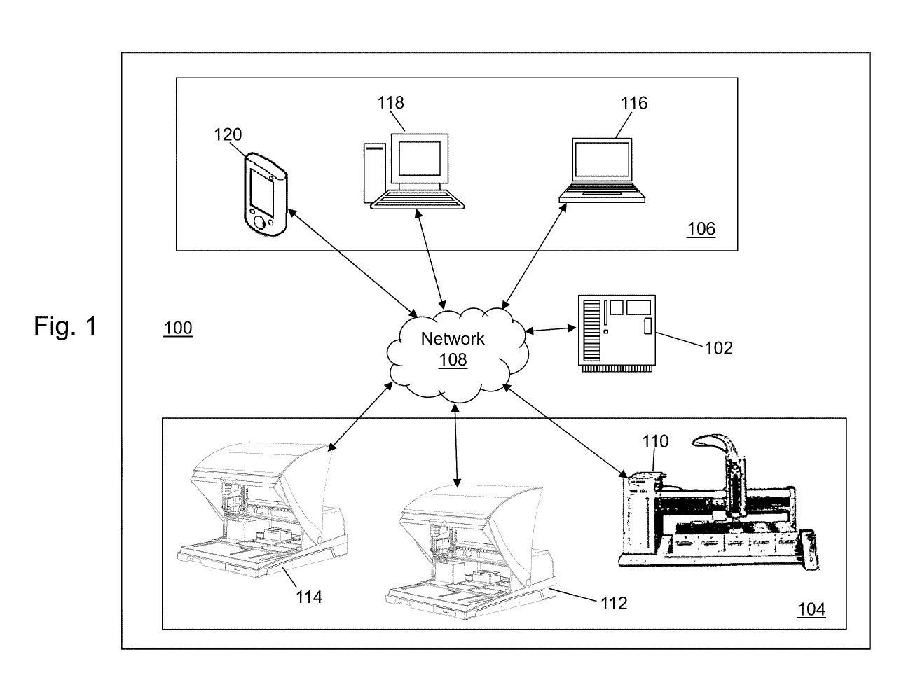

Referring to FIG. 1, a block diagram of a liquid handling system 100 is shown in accordance with an illustrative embodiment. In an illustrative embodiment, liquid handling system 100 may include a server 102, one or more liquid handlers 104, one or more protocol creation devices 106, and a network 108. The components of liquid handling system 100 may be distributed geographically from one another, may be integrated into one or more devices, and/or may be directly connected or connected through network 108.

Network 108 supports communication between the components of liquid handling system 100. Network 108 may include one or more networks of the same or different types. Network 108 can be any type of wired and/or wireless public or private network including a cellular network, a local area network, a wide area network such as the Internet, etc. Network 108 further may comprise sub-networks and consist of any number of devices.

In the illustrative embodiment, server 102 may include one or more computing devices of any form factor. Server 102 may send and receive signals through network 108 to/from the one or more liquid handlers 104 and/or to/from the one or more protocol creation devices 106. Server 102 may also be a protocol creation device. Server 102 may communicate using various transmission media that may be wired and/or wireless as understood by those skilled in the art.

The one or more liquid handlers 104 can include any number of liquid handlers that may be the same or different. The one or more liquid handlers 104 may include any type and brand of liquid handler used in pharmaceutical, genomic, and proteomic research, drug development laboratories, clinical laboratories, diagnostic laboratories and other biotechnology applications that handle laboratory samples in a variety of laboratory procedures. For example, the one or more liquid handlers 104 may be used for biotechnological and pharmaceutical liquid assay procedures, compound distribution, microarray manufacturing, sample preparation for liquid chromatography analysis, for quantitative polymerase chain reaction (qPCR) analysis, molecular biology analysis, genomic sequencing, cellular assay procedures, etc. For illustration, the one or more liquid handlers 104 may include a first liquid handler 110, a second liquid handler 112, a third liquid handler 114, etc. The one or more liquid handlers 104 may communicate using various transmission media that may be wired and/or wireless as understood by those skilled in the art. The one or more liquid handlers 104 may send and receive signals through network 108 to/from the one or more protocol creation devices 106 and/or to/from server 102.

The one or more protocol creation devices 106 can include any number and type of computing devices. The one or more protocol creation devices 106 may include computers of any form factor such as a laptop 116, a desktop 118, a smart phone 120, a personal digital assistant, an integrated messaging device, a tablet computer, etc. The one or more protocol creation devices 106 may communicate using various transmission media that may be wired and/or wireless as understood by those skilled in the art. The one or more protocol creation devices 106 send and receive signals through network 108 to/from another of the one or more protocol creation devices 106 and/or to/from server 102 and/or to/from the one or more liquid handlers 104.

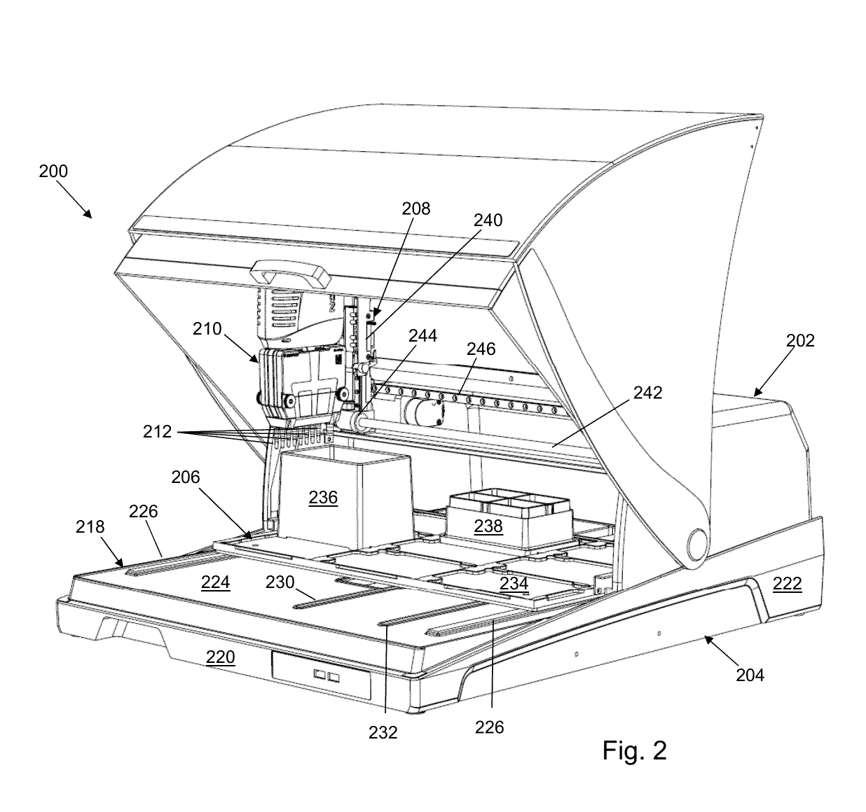

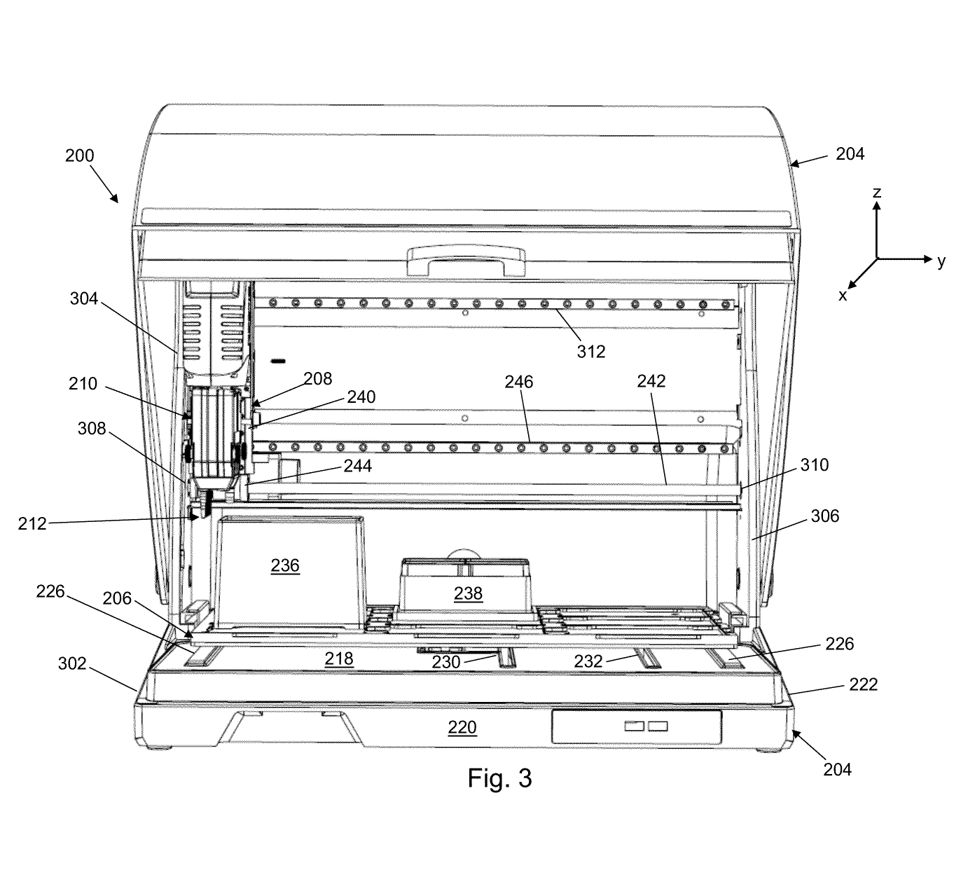

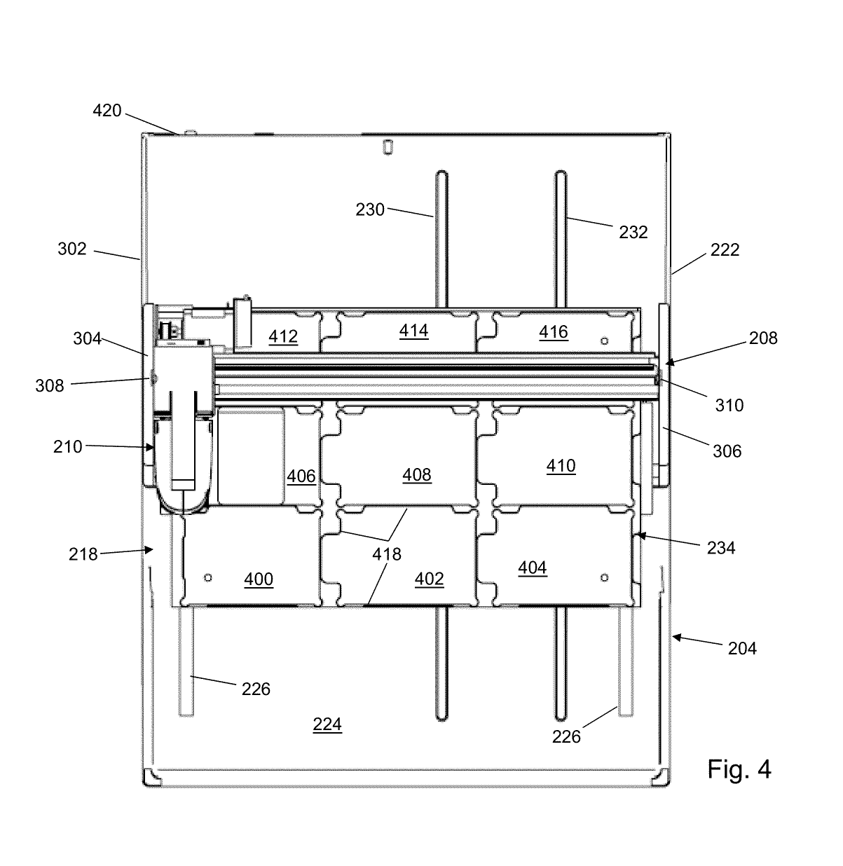

With reference to FIGS. 2 to 4, views of a liquid handler 200 of the one or more liquid handlers 104 are shown in accordance with an illustrative embodiment. With reference to FIG. 2, a right perspective view of liquid handler 200 is shown. With reference to FIG. 3, a front view of liquid handler 200 is shown. With reference to FIG. 4, a top view of liquid handler 200 is shown. Liquid handler 200 includes any type of device that performs aspiration and/or dispensation of liquid to support analysis and preparation of a sample for high-pressure liquid chromatography, solid phase extraction, qPCR analysis, etc.

In the illustrative embodiment, liquid handler 200 may include a cover 202, a base 204, a work bed 206, a drive system 208, a liquid handling head 210, and a plurality of pipetting heads 212. The components of liquid handler 200 may be formed of a variety of materials including one or more metals or plastics having a sufficient strength and rigidity for the described application. Liquid handler 200 may include additional, fewer, or different components. For example, cover 202 is optional and may be completely or partially removable from base 204.

Cover 202 is mounted to base 204 to protect the components of liquid handler 200. Base 204 may include a base plate 218, a front wall 220, a right side wall 222, a left side wall 302 (shown with reference to FIG. 3), and a back wall 420 (shown with reference to FIG. 4). The walls 220, 222, 302, 420 may have a variety of shapes that extend from base plate 218. The walls 220, 222, 302, 420 and base plate 218 may be molded as a single piece. Though feet may be mounted to the walls 220, 222, 302, 420, the walls 220, 222, 302, 420 and base plate 218 generally provide a support structure for liquid handler 200.

As used in this disclosure, the term “mount” includes join, unite, connect, associate, insert, hang, hold, affix, attach, fasten, bind, paste, secure, bolt, screw, rivet, solder, weld, glue, abut, mold, thermoform, couple, nail, etc. The phrases “mounted on” and “mounted to” include any interior or exterior portion of the support member referenced. These phrases also encompass direct mounting (in which the referenced elements are in direct contact) and indirect mounting (in which the referenced elements are not in direct contact and are mounted together via intermediate elements). Additionally, some components may be mounted to each other by molding or thermoforming such that the components form a single integral component. Use of directional terms, such as top, bottom, right, left, front, back, etc. are merely intended to facilitate reference to the various surfaces that form components of liquid handler 200 and are not intended to be limiting in any manner.

Base plate 218 includes a top surface 224, a plurality of supports 226, a first elongated slot 230, and a second elongated slot 232. The plurality of supports 226 protrude from top surface 224 to support work bed 206 above top surface 224 of base plate 218.

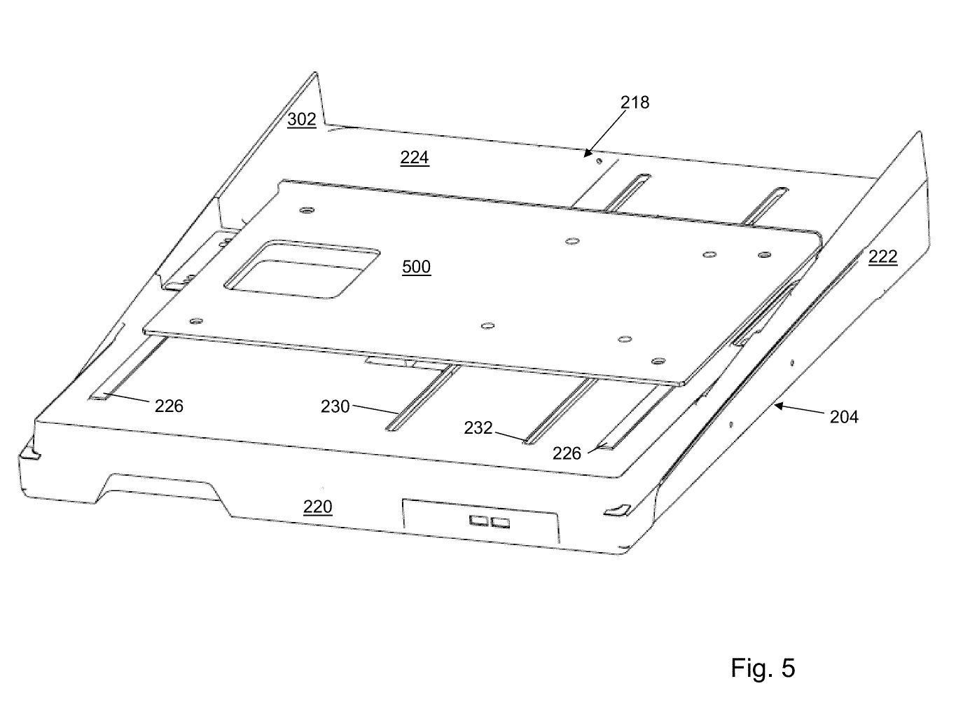

With reference to FIG. 5, a top perspective view of base 204 of liquid handler 200 is shown. First elongated slot 230 and second elongated slot 232 are formed through base plate 224 to allow insertion of a plurality of legs (not shown) of a bearing carriage (not shown) and a translating plate 500. The plurality of legs may mount translating plate 500 to the bearing carriage. In the illustrative embodiment, the plurality of supports 226, first elongated slot 230, and second elongated slot 232 are elongated in approximately parallel directions to each other and to right side wall 222 and left side wall 302. The plurality of supports 226, first elongated slot 230, and second elongated slot 232 are further elongated in the direction of translation of translating plate 500.

With continuing reference to FIGS. 2 to 4, work bed 206 may include translating plate 500 and a rack plate 234. Rack plate 234 is mounted on translating plate 500. In alternative embodiments, work bed 206 may include a single plate. Work bed 206 may be fixedly or removably mounted on the plurality of legs. Work bed 206 may have a variety of shapes (circular, elliptical, polygonal, etc.) and sizes based on the processing performed by liquid handler 200. Work bed 206 further may be formed of a variety of materials based on the processing performed by liquid handler 200. For example, a metal or plastic may be used to form work bed 206. Rack plate 234 may be fixedly or removably mounted on translating plate 500.

With reference to FIG. 4, rack plate 234 may include a plurality of ridges 418 that extend up from rack plate 134 away from translating plate 500. The plurality of ridges 418 provide a layout for racks though other sized and shaped racks may be mounted on rack plate 234 in other locations. Rack plate 234 includes a first cavity 400, a second cavity 402, a third cavity 404, a fourth cavity 406, a fifth cavity 408, a sixth cavity 410, a seventh cavity 412, an eighth cavity 414, and a ninth cavity 416 formed as a 3×3 grid by the plurality of ridges 418. Merely for illustration, in FIGS. 2 and 3, a first rack 236 is shown mounted in fourth cavity 406, and a second rack 238 is shown mounted in eighth cavity 414 of rack plate 234.

First rack 236 and second rack 238 are configured to hold one or more receptacles. The one or more receptacles are configured to hold a sample for analysis and/or a liquid used for analysis of the sample and/or a liquid used for preparation of the sample. For illustration, the one or more receptacles may be vials, test tubes, bottles, etc. of various shapes and sizes. The sample may be in liquid or solid form. Pumps, diluters, valves, heaters, chillers, analysis components, microplates, etc. further may be mounted on or to rack plate 234.

With reference to FIG. 3, drive system 208 may include a first side wall 304, a second side wall 306, a device support structure 240, a lead screw 242, a lead screw interface 244, a first bracket 308, a second bracket 310, a first bearing rail 246, and a second bearing rail 312. First side wall 304 and second side wall 306 are mounted to base 204 to extend up from base plate 218. First bracket 308 is mounted to first side wall 304. Second bracket 310 is mounted to second side wall 306. Lead screw 242 is mounted between first support bracket 304 and second support bracket 306. Lead screw interface 244 is mounted to device support structure 240, and lead screw 242 is mounted to lead screw interface 244. Device support structure 240 translates along lead screw 242. Device support structure 240 further may be mounted to first bearing rail 246 and second bearing rail 312. Device support structure 240 also translates along first bearing rail 246 and second bearing rail 312.

In an illustrative embodiment, an actuator is mounted to control movement of device support structure 240 along lead screw 242. Illustrative actuators include an electric motor, a servo, stepper, or piezo motor, a pneumatic actuator, a gas motor, etc. Drive system 208 may include one or more actuators operably coupled to control movement of device support structure 240 to position the plurality of pipetting heads 212 over a receptacle mounted on rack plate 234. Drive system 208 may provide movement of device support structure 240 in one-dimension, two-dimensions, or three-dimensions relative to rack plate 234. In the illustrative embodiment of FIGS. 2 to 4, drive system 208 provides movement of the plurality of pipetting heads 212 in two-dimensions (y-z) relative to rack plate 234. Of course, drive system 208 can be figured to provide movement in one-dimension or three-dimensions in alternative embodiments.

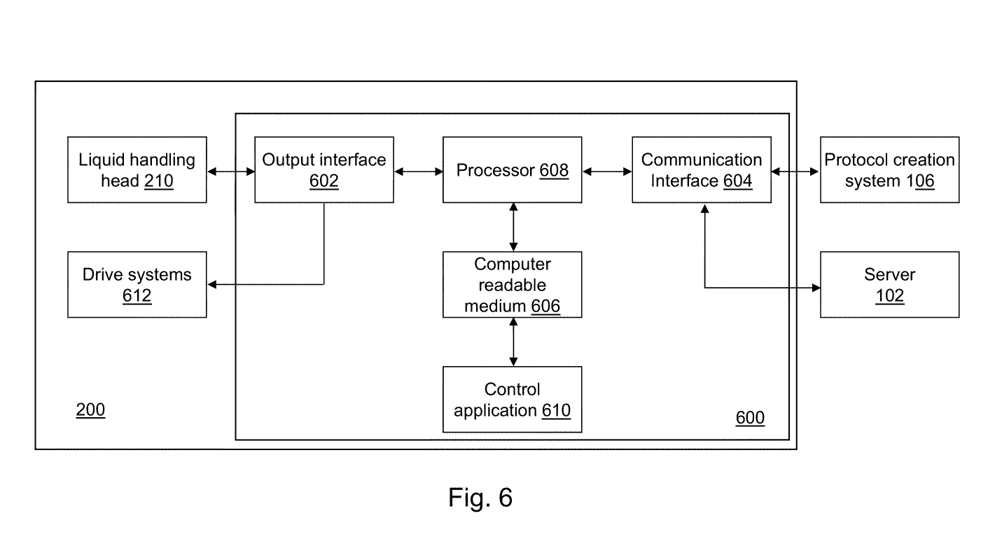

Referring to FIG. 6, a block diagram of components of liquid handler 200 is shown in accordance with an illustrative embodiment. With reference to FIG. 6, liquid handler 200 may include a controller 600, liquid handling head 210, and one or more drive systems 612. Controller 600 controls the operation of the components of liquid handler 200. The one or more drive systems 612 control movement of device support structure 240 and/or of rack plate 234. Controller 600 may be operably coupled to the one or more drive systems 612 to control movement of device support structure 240 and/or work bed 206 and/or rack plate 234. Controller 600 may also control liquid pumping including aspirating and dispensing to/from liquid handling head 210. Controller 600 may include a printed circuit board (not shown) mounted on a surface of liquid handler 200.

For example, the one or more drive systems 612 may include drive system 208 and a second drive system (not shown). In this alternative, drive system 208 controls movement of device support structure 240 in one-dimension (y) or two-dimensions (y-z) relative to rack plate 234, while the second drive system controls movement of rack plate 234 in one-dimension (x) relative to base 204. Liquid handling head 210 provides aspiration/dispensation of sample or other liquids through the plurality of pipetting heads 212 and into or out of a receptacle mounted on rack plate 234 when liquid handling head 210 is appropriately positioned over the receptacle.

Controller 600 may include an controller output interface 602, a controller communication interface 604, a controller computer-readable medium 606, a controller processor 608, and a control application 610. Different, fewer, and additional components may be incorporated into controller 600.

Controller output interface 602 provides an interface for outputting information to the one or more drive systems 612 and/or liquid handling head 210 as understood by those skilled in the art. Controller 600 may have one or more output interfaces that use the same or a different interface technology.

Controller communication interface 604 provides an interface for receiving and transmitting data between devices using various protocols, transmission technologies, and media as known to those skilled in the art. Controller communication interface 604 may support communication using various transmission media that may be wired or wireless. Illustrative wireless communication devices include antennas that receive and transmit electromagnetic radiation at various frequencies. Controller 600 may have one or more communication interfaces that use the same or a different communication interface technology. Data and messages may be transferred between any input or output device and controller 600 using controller communication interface 604. Thus, controller communication interface 604 provides an alternative interface to either or both of an input interface (not shown) and controller output interface 602.

Controller 600 may be linked to one or more interfaced devices. For example, controller 600 may interface with protocol creation system 104 and/or server 102. If connected, controller 600 and protocol creation system 104 and/or server 102 may be connected directly or through network 108. For example, controller 600 may receive a protocol for execution by liquid handler 200 from protocol creation system 104 and/or server 102 and send results obtained for a sample for storage on protocol creation system 104 and/or server 102. The protocol includes a sequence of commands configured to control operation of one or more components of liquid handler 200 such as the one or more drive systems 612 and/or liquid handling head 210.

Controller computer-readable medium 606 is an electronic holding place or storage for information so that the information can be accessed by controller processor 608 as understood by those skilled in the art. Controller computer-readable medium 606 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., CD, DVD, . . . ), smart cards, flash memory devices, etc. Controller 600 may have one or more computer-readable media that use the same or a different memory media technology. Controller 600 also may have one or more drives that support the loading of a memory media such as a CD or DVD.

Controller processor 608 executes instructions as known to those skilled in the art. The instructions may be carried out by a special purpose computer, logic circuits, or hardware circuits. Thus, controller processor 608 may be implemented in hardware, firmware, or any combination of these methods. The term “execution” is the process of running an application or the carrying out of the operation called for by an instruction. The instructions may be written using one or more programming language, scripting language, assembly language, etc. Controller processor 608 executes an instruction, meaning that it performs/controls the operation(s) called for by that instruction. Controller processor 608 operably couples with controller computer-readable medium 606, with controller communication interface 604, and with controller output interface 602 to receive, to send, and to process information. Controller processor 608 may retrieve a set of instructions from a permanent memory device and copy the instructions in an executable form to a temporary memory device that is generally some form of RAM. As an example, controller processor 608 may execute a protocol received from protocol creation system 104 and/or server 102. Controller 600 may include a plurality of processors that use the same or a different processing technology.

Control application 610 performs operations associated with controlling, maintaining, updating, etc. the operation of liquid handler 200. Some or all of the operations described herein may be controlled by instructions embodied in control application 610. The operations may be implemented using hardware, firmware, software, or any combination of these methods. With reference to the example embodiment of FIG. 6, control application 610 is implemented in software (comprised of computer-readable and/or computer-executable instructions) stored in controller computer-readable medium 606 and accessible by controller processor 608 for execution of the instructions that embody the operations of control application 610. Control application 610 may be written using one or more programming languages, assembly languages, scripting languages, etc.

Control application 610 may be configured to identify characteristics of rack plate 234 such as a model number, a number of receptacles, an indicator of a geometrical arrangement of the receptacles, etc. Control application 610 further may be configured to receive information identifying a content of the one or more receptacles, an indicator of one or more processing steps performed on the one or more receptacles, an indicator of one or more processing steps to be performed on the one or more receptacles, an indicator of where work bed 206 should be positioned on base plate 218, an indicator of one or more devices that have interacted with work bed 206, etc. As an example, execution of a protocol received from protocol creation system 104 and/or server 102 may be controlled by control application 610 either automatically when the protocol is received or under control of a user through an interface provided to allow the user to select the protocol for execution. The protocol may include the characteristics of rack plate 234, the information identifying a content of the one or more receptacles, an indicator of one or more processing steps performed on the one or more receptacles, an indicator of one or more processing steps to be performed on the one or more receptacles, an indicator of where work bed 206 should be positioned on base plate 218, an indicator of one or more devices that have interacted with work bed 206, etc.

Referring to FIG. 7, a block diagram of a protocol creation device 700 is shown in accordance with an illustrative embodiment. Protocol creation device 700 may include an input interface 702, an output interface 704, a communication interface 706, a computer-readable medium 708, a processor 710, a protocol creation application 712, a database 714, a keyboard 716, a mouse 718, a display 720, a printer 722, and a speaker 724. Different, fewer, and additional components may be incorporated into protocol creation device 700.

Input interface 702 provides an interface for receiving information from the user for entry into protocol creation device 700 as understood by those skilled in the art. Input interface 702 may interface with various input technologies including, but not limited to, keyboard 716, mouse 718, display 720, a track ball, a keypad, one or more buttons, etc. to allow the user to enter information into protocol creation device 700 or to make selections in a user interface displayed on display 720. Display 720 may be a thin film transistor display, a light emitting diode display, a liquid crystal display, or any of a variety of different display types as understood by those skilled in the art. Keyboard 716 may be any of a variety of keyboard types as understood by those skilled in the art. Mouse 718 may be any of a variety of mouse type devices as understood by those skilled in the art.

The same interface may support both input interface 702 and output interface 704. For example, a display comprising a touch screen both allows user input and presents output to the user. Protocol creation device 700 may have one or more input interfaces that use the same or a different input interface technology. Keyboard 716, mouse 718, display 720, etc. further may be accessible by protocol creation device 700 through communication interface 706.

Output interface 704 provides an interface for outputting information for review by a user of protocol creation device 700. For example, output interface 704 may interface with various output technologies including, but not limited to, display 720, printer 722, speaker 724, etc. Printer 722 may be any of a variety of printer types as understood by those skilled in the art. Speaker 724 may be any of a variety of speaker types as understood by those skilled in the art. Protocol creation device 700 may have one or more output interfaces that use the same or a different interface technology. Speaker 724, printer 722, etc. further may be accessible by protocol creation device 700 through communication interface 706.

Communication interface 706 provides an interface for receiving and transmitting data between devices using various protocols, transmission technologies, and media as understood by those skilled in the art. Communication interface 706 may support communication using various transmission media that may be wired and/or wireless. Protocol creation device 700 may have one or more communication interfaces that use the same or a different communication interface technology. Data and messages may be transferred between protocol creation device 700 and liquid handler 200 and/or server 102 using communication interface 706.

Computer-readable medium 708 is an electronic holding place or storage for information so the information can be accessed by processor 710 as understood by those skilled in the art. Computer-readable medium 708 can include, but is not limited to, any type of RAM, any type of ROM, any type of flash memory, etc. such as magnetic storage devices (e.g., hard disk, floppy disk, magnetic strips, . . . ), optical disks (e.g., CD, DVD, . . . ), smart cards, flash memory devices, cache memory, etc. Protocol creation device 700 may have one or more computer-readable media that use the same or a different memory media technology. Protocol creation device 700 also may have one or more drives that support the loading of a memory media such as a CD or DVD.

Processor 710 executes instructions as understood by those skilled in the art. The instructions may be carried out by a special purpose computer, logic circuits, or hardware circuits. Processor 710 may be implemented in hardware and/or firmware, or any combination of these methods. The term “execution” is the process of running an application or the carrying out of the operation called for by an instruction. The instructions may be written using one or more programming language, scripting language, assembly language, etc. Processor 710 executes an instruction, meaning it performs/controls the operations called for by that instruction. Processor 710 operably couples with input interface 702, with output interface 704, with communication interface 706, and with computer-readable medium 708 to receive, to send, and to process information. Processor 710 may retrieve a set of instructions from a permanent memory device and copy the instructions in an executable form to a temporary memory device that is generally some form of RAM. Protocol creation device 700 may include a plurality of processors that use the same or a different processing technology.

Protocol creation application 712 performs operations associated with creating a protocol for execution by controller processor 608 to control the operation of liquid handler 200. Some or all of the operations described herein may be embodied in protocol creation application 712. The operations may be implemented using hardware, firmware, software, or any combination of these methods. Referring to the example embodiment of FIG. 7, protocol creation application 712 is implemented in software (comprised of computer-readable and/or computer-executable instructions) stored in computer-readable medium 708 and accessible by processor 710 for execution of the instructions that embody the operations of protocol creation application 712. Protocol creation application 712 may be written using one or more programming languages, assembly languages, scripting languages, etc.

Protocol creation application 712 may be implemented as a Web application. For example, protocol creation application 712 may be configured to receive hypertext transport protocol (HTTP) responses from server 102 and to send HTTP requests to server 102. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol. The file accessed may be a simple text file, an image file, an audio file, a video file, an executable, a common gateway interface application, a Java applet, an extensible markup language (XML) file, or any other type of file supported by HTTP.

Protocol creation device 700 may further include a browser application (not shown) as understood by a person of skill in the art. The browser application performs operations associated with retrieving, presenting, and traversing information resources provided by a web application and/or web server as known to those skilled in the art. An information resource is identified by a uniform resource identifier (URI) and may be a web page, image, video, or other piece of content. Hyperlinks in resources enable users to navigate to related resources. Example browser applications include Navigator by Netscape Communications Corporation, Firefox® by Mozilla Corporation, Opera by Opera Software Corporation, Internet Explorer® by Microsoft Corporation, Safari by Apple Inc., Chrome by Google Inc., etc. as known to those skilled in the art.

Protocol creation device 700 may include database 714 stored on computer-readable medium 708 or can access database 714 either through a direct connection or through network 108 using communication interface 706. Database 714 is a data repository for liquid handling system 100. For example, the data processed using protocol creation application 712 may be stored in database 714. Database 714 may include a plurality of databases that may be organized into multiple database tiers to improve data management and access. Database 714 may be stored in one or more storage locations distributed over the network and using the same or different formats. Database 714 may utilize various database technologies and a variety of formats as known to those skilled in the art including a file system, a relational database, a system of tables, a structured query language database, an XML file, etc.

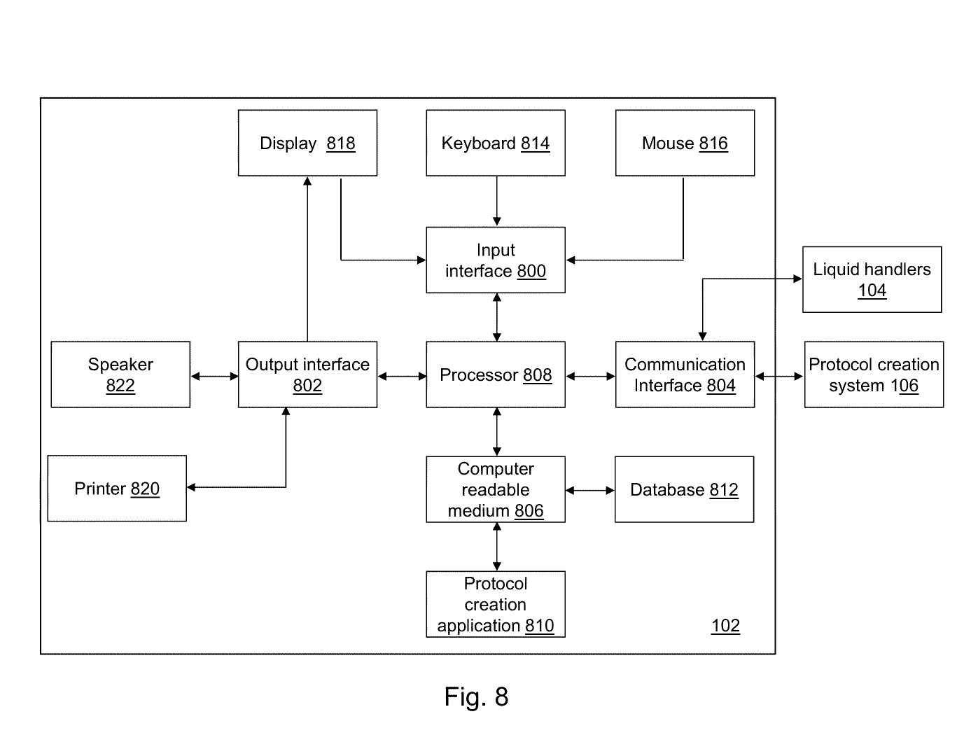

Referring to FIG. 8, a block diagram of server 102 is shown in accordance with an illustrative embodiment. Server 102 may include a second input interface 800, a second output interface 802, a second communication interface 804, a second computer-readable medium 806, a second processor 808, a second protocol creation application 810, a second database 812, a second keyboard 814, a second mouse 816, a second display 818, a second printer 820, and a second speaker 822. Fewer, different, and additional components may be incorporated into server 102.

Second input interface 800 provides the same or similar functionality as that described with reference to input interface 702 of protocol creation device 700 though referring to server 102 instead of protocol creation device 700. Second output interface 802 provides the same or similar functionality as that described with reference to output interface 704 of protocol creation device 700 though referring to server 102 instead of protocol creation device 700. Second communication interface 804 provides the same or similar functionality as that described with reference to communication interface 706 of protocol creation device 700 though referring to server 102 instead of protocol creation device 700. Data and messages may be transferred between server 102 and protocol creation device 700 using second communication interface 804.

Second computer-readable medium 806 provides the same or similar functionality as that described with reference to computer-readable medium 708 of protocol creation device 700 though referring to server 102 instead of protocol creation device 700. Second processor 808 provides the same or similar functionality as that described with reference to processor 710 of protocol creation device 700 though referring to server 102 instead of protocol creation device 700. Second keyboard 814 provides the same or similar functionality as that described with reference to keyboard 716 of protocol creation device 700 though referring to server 102 instead of protocol creation device 700. Second mouse 816 provides the same or similar functionality as that described with reference to mouse 718 of protocol creation device 700 though referring to server 102 instead of protocol creation device 700. Second display 818 provides the same or similar functionality as that described with reference to display 720 of protocol creation device 700 though referring to server 102 instead of protocol creation device 700. Second speaker 822 provides the same or similar functionality as that described with reference to speaker 722 of protocol creation device 700 though referring to server 102 instead of protocol creation device 700. Second printer 820 provides the same or similar functionality as that described with reference to printer 724 of protocol creation device 700 though referring to server 102 instead of protocol creation device 700.

Second protocol creation application 810 may be implemented as a Web application. For example, second protocol creation application 810 may be configured to send HTTP responses to other computing devices, such as protocol creation device 700, and to receive HTTP requests from other computing devices, such as protocol creation device 700. The HTTP responses may include web pages such as HTML documents and linked objects generated in response to the HTTP requests. Each web page may be identified by a URL that includes the location or address of the computing device that contains the resource to be accessed in addition to the location of the resource on that computing device. The type of file or resource depends on the Internet application protocol. The file accessed may be a simple text file, an image file, an audio file, a video file, an executable, a common gateway interface application, a Java applet, an XML file, or any other type of file supported by HTTP.

Control application 610, protocol creation application 712, and/or second protocol creation application 810 may be the same or different applications or part of an integrated, distributed application supporting some or all of the same or additional types of functionality as described herein. Various levels of integration between the components of liquid handling system 100 may be implemented without limitation as understood by a person of skill in the art.

Second database 812 and database 714 may be a single integrated database stored on computer-readable medium 708 and/or on second computer-readable medium 806 or on another computing device accessible through network 108 using second communication interface 804. Thus, protocol creation application 712, and/or second protocol creation application 810 may save or store data to second database 812 and/or database 714 and access or retrieve data from second database 812 and/or database 714.

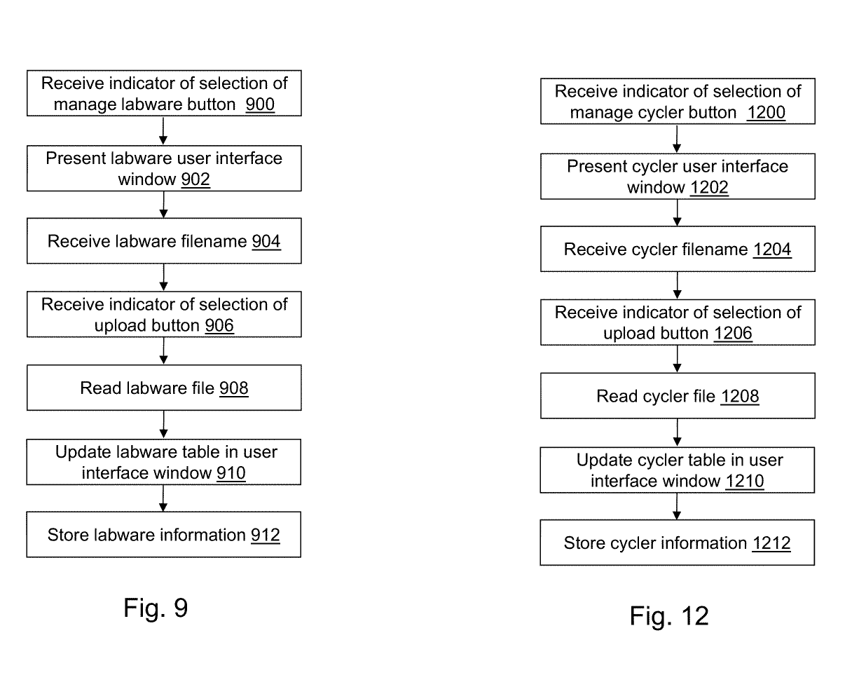

Referring to FIG. 9, example operations associated with protocol creation application 712 and/or second protocol creation application 810 are described. Additional, fewer, or different operations may be performed depending on the embodiment. The order of presentation of the operations of FIG. 9 is not intended to be limiting. A user can interact with one or more user interface windows presented to the user in display 720 or in second display 818 under control of protocol creation application 712 and/or second protocol creation application 810 independently or through the browser application in an order selectable by the user as understood by a person of skill in the art. Although some of the operational flows are presented in sequence, the various operations may be performed in various repetitions, concurrently (in parallel), and/or in other orders than those that are illustrated.

For example, a user may execute protocol creation application 712 and/or second protocol creation application 810, which causes presentation of a first user interface window, which may include a plurality of menus and selectors such as drop down menus, buttons, text boxes, hyperlinks, etc. associated with protocol creation application 712 and/or second protocol creation application 810 as understood by a person of skill in the art. Protocol creation application 712 and/or second protocol creation application 810 controls the presentation of one or more additional user interface windows that further may include menus and selectors such as drop down menus, buttons, text boxes, hyperlinks, additional windows, etc. based on user selections received by protocol creation application 712 and/or second protocol creation application 810.

As understood by a person of skill in the art, the user interface windows are presented on display 720 and/or on second display 818 under control of the computer-readable and/or computer-executable instructions of protocol creation application 712 and/or second protocol creation application 810 executed by processor 710 or second processor 808. As the user interacts with the user interface windows, different user interface windows may be presented to provide the user with various controls from which the user may make selections or enter values associated with various application controls. In response, as understood by a person of skill in the art, protocol creation application 712 and/or second protocol creation application 810 receive an indicator associated with an interaction by the user with the user interface window. Based on the received indicator, protocol creation application 712 and/or second protocol creation application 810 perform one or more additional operations.

For example, with reference to FIG. 10, a first user interface window 1000 presented under control of protocol creation application 712 and/or second protocol creation application 810 may include a manage labware button 1002, a manage qPCR cycler button 1004, a manage qPCR analyses button 1006, and a create qPCR experiment button 1008. In the illustrative embodiment, protocol creation application 712 and/or second protocol creation application 810 are configured to create protocols in support of qPCR experiments though protocol creation application 712 and/or second protocol creation application 810 may be configured to support other types of experiments as understood by a person of skill in the art based on the description provided herein.

In an operation 900, an indicator of user selection of manage labware button 1002 is received. In an operation 902, a labware user interface window is presented. For example, with reference to FIG. 11, a labware user interface window 1100 may include a find labware file button 1102, a labware filename window 1104, a labware file upload button 1106, and a labware table 1108. A user may select find labware file button 1102 to locate a labware file, for example, stored in database 714 or on computer-readable medium 708. A selected filename may be presented in labware filename window 1104 or the user may enter a filename in labware filename window 1104, for example, using keyboard 716.

In an operation 904, a labware filename is received from labware filename window 1104. In an operation 906, an indicator of user selection of labware file upload button 1106 is received. In an operation 908, the uploaded labware file is read. In an operation 910, a new row of information is added to labware table 1108. In an operation 912, information read from the uploaded labware file is stored, for example, in database 714 or on computer-readable medium 708.

The labware file contains information describing the labware. For example, the labware may include racks positioned on work bed 206 and containing one or more receptacles configured to hold a sample for analysis and/or a liquid used for analysis of the sample and/or a liquid used for preparation of the sample. Racks may also hold tips. The labware file contains information on identification of the labware (type of element, name, number, type of receptacle(s)), the dimensions of the labware, location, volume capacity of each individual receptacle or tip, formulas describing the geometry of these wells, etc. This information is integrated into the protocol for liquid handler 200 during the protocol creation.

Labware table 1108 includes a plurality of labware rows 1110 with one row defined for each labware file uploaded and read. Labware table 1108 may include a plurality of columns of information for each row of the plurality of labware rows 1110. For example, labware table 1108 may include a labware name column 1112, a holder type column 1114, a size column 1116, a minimum volume column 1118, and a maximum volume column 1120 for each row of the plurality of labware rows 1110. Labware name column 1112 includes a descriptive name for the labware that may be used with liquid handler 200, for example, by positioning the labware on rack plate 234. Holder type column 1114 includes a holder type for the labware, such as “microplate”, “tip rack”, “well holder”, etc. Size column 1116 includes a size of the labware. For example, the size may indicate the number of receptacles, tips, wells, etc. included on the labware. Minimum volume column 1118 and maximum volume column 1120 indicate a minimum and a maximum volume, respectively, held by each receptacle, tip, well, etc. included on the labware.

A labware delete button 1122 may be associated with a labware file. When an indicator is received indicating selection of labware delete button 1122, the associated labware information is deleted and the associated row removed from labware table 1108.

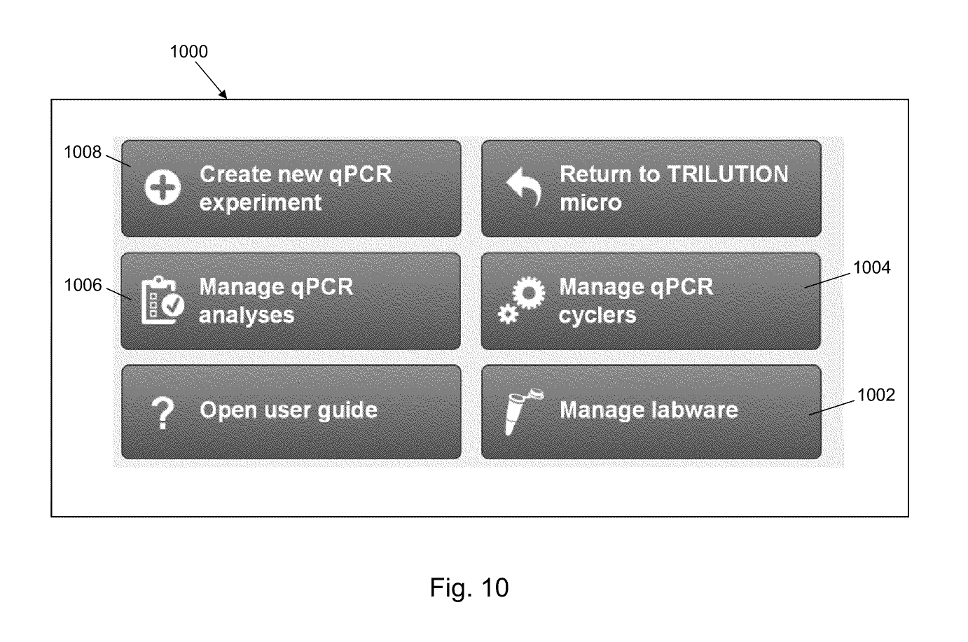

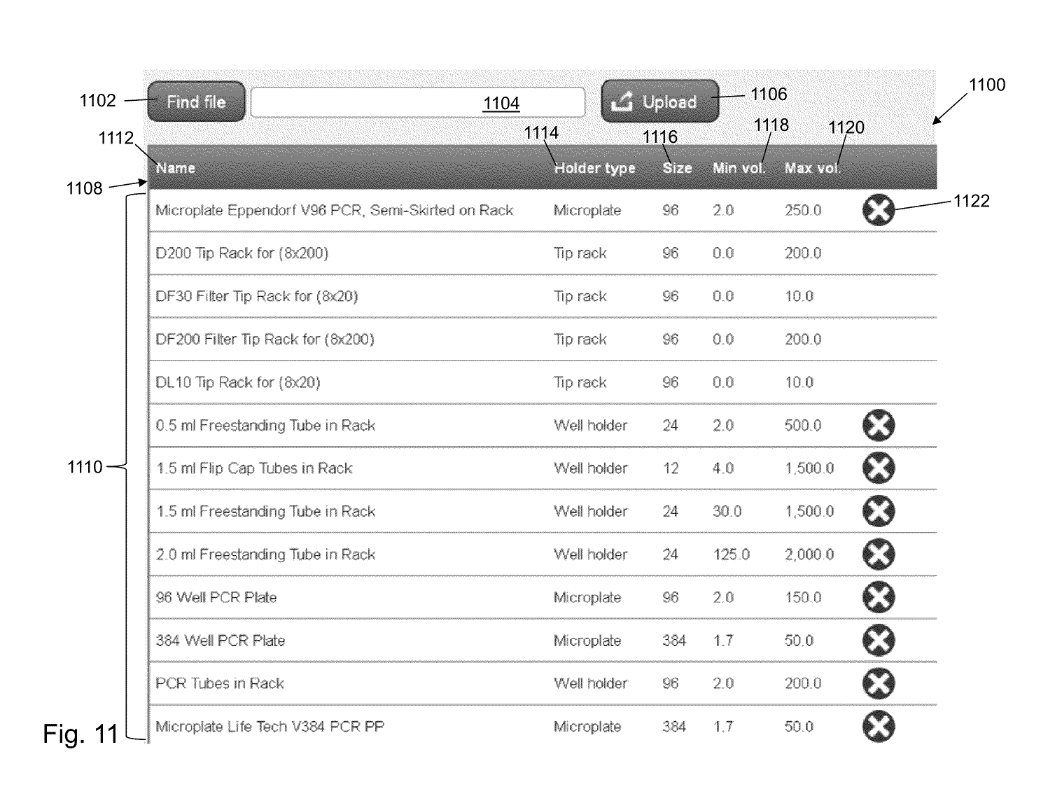

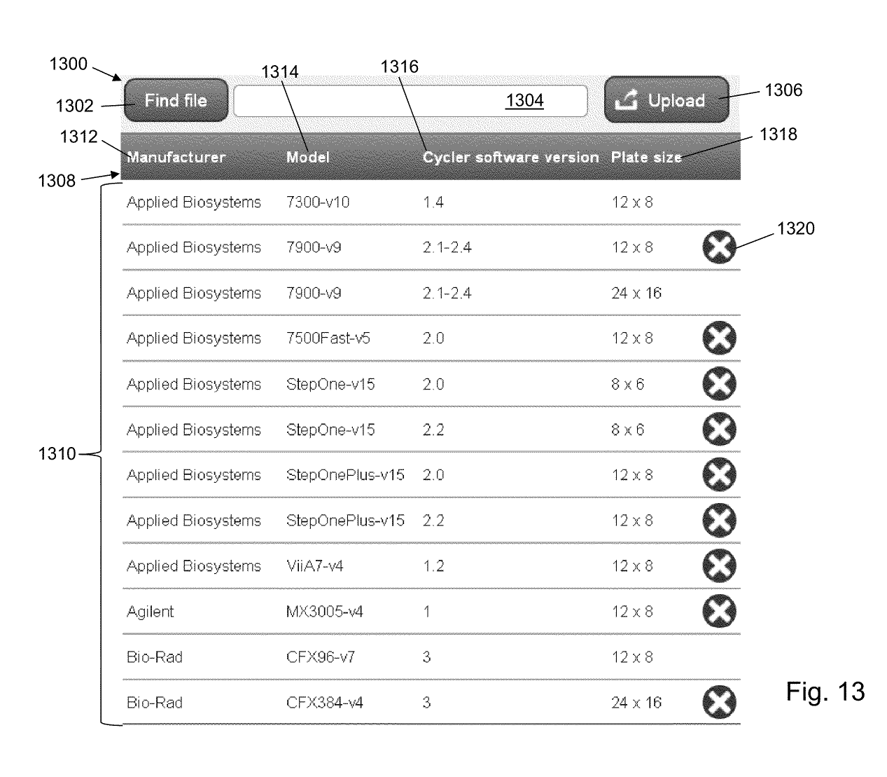

Referring to FIG. 12, additional example operations associated with protocol creation application 712 and/or second protocol creation application 810 are described. Additional, fewer, or different operations may be performed depending on the embodiment. The order of presentation of the operations of FIG. 12 is not intended to be limiting. A user can interact with one or more user interface windows presented to the user in display 720 or in second display 818 under control of protocol creation application 712 and/or second protocol creation application 810 independently or through the browser application in an order selectable by the user as understood by a person of skill in the art. Although some of the operational flows are presented in sequence, the various operations may be performed in various repetitions, concurrently (in parallel), and/or in other orders than those that are illustrated.

In an operation 1200, an indicator of user selection of qPCR cycler button 1004 is received. In an operation 1202, a qPCR cycler user interface window is presented. For example, with reference to FIG. 13, a qPCR cycler user interface window 1300 may include a find qPCR cycler file button 1302, a qPCR cycler filename window 1304, a qPCR cycler file upload button 1306, and a qPCR cycler table 1308. A user may select find qPCR cycler file button 1302 to locate a qPCR cycler file, for example, stored in database 714 or on computer-readable medium 708. A selected filename may be presented in qPCR cycler filename window 1304 or the user may enter a filename in qPCR cycler filename window 1304, for example, using keyboard 716.

In an operation 1204, a qPCR cycler filename is received from qPCR cycler filename window 1304. In an operation 1206, an indicator of user selection of qPCR cycler file upload button 1306 is received. In an operation 1208, the uploaded labware file is read. In an operation 1210, a new row of information is added to qPCR cycler table 1308. In an operation 1212, information read from the uploaded qPCR cycler file is stored, for example, in database 714 or on computer-readable medium 708. The qPCR cycler file contains information for automatically setting-up a qPCR run on a qPCR Cycler including, but not limited to, a qPCR plate format, sample positions on the qPCR plate, sample names, information about reporters and their position, sample type information (e.g. unknown, NTC, . . . ), information on single/multiplex run, etc. The qPCR cycler file is readable by a qPCR cycler.

qPCR cycler table 1308 includes a plurality of rows 1310 with one row defined for each qPCR cycler file uploaded and read. qPCR cycler table 1308 may include a plurality of columns of information for each row of the plurality of rows 1310. For example, qPCR cycler table 1308 may include a manufacturer name column 1312, a model type column 1314, a software version column 1316, and a plate size column 1318 for each row of the plurality of rows 1310. Manufacturer name column 1312 includes a descriptive name for the manufacture of the qPCR cycler that may be used with a qPCR sample prepared using liquid handler 200. Model type column 1314 includes a model type identifier for the qPCR cycler. Software version column 1316 includes a software version identifier for the qPCR cycler. Plate size column 1318 includes a plate size for the qPCR cycler. For example, the plate size may indicate the number of receptacles included on a rack positioned on rack plate 234 for preparation of the qPCR sample using liquid handler 200.

A qPCR cycler delete button 1320 may be associated with a qPCR cycler file. When an indicator is received indicating selection of qPCR cycler delete button 1320, the associated qPCR cycler information is deleted and the associated row removed from qPCR cycler table 1308.

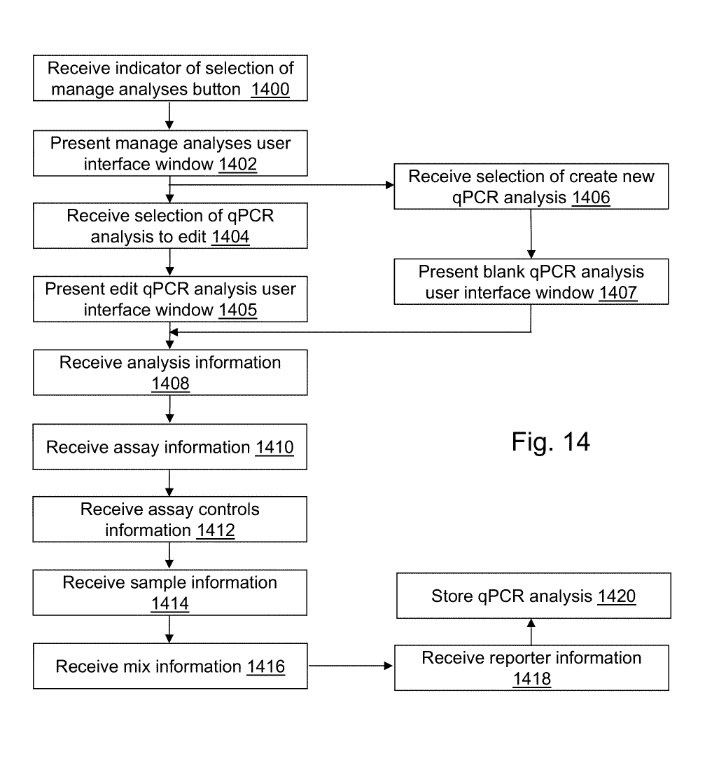

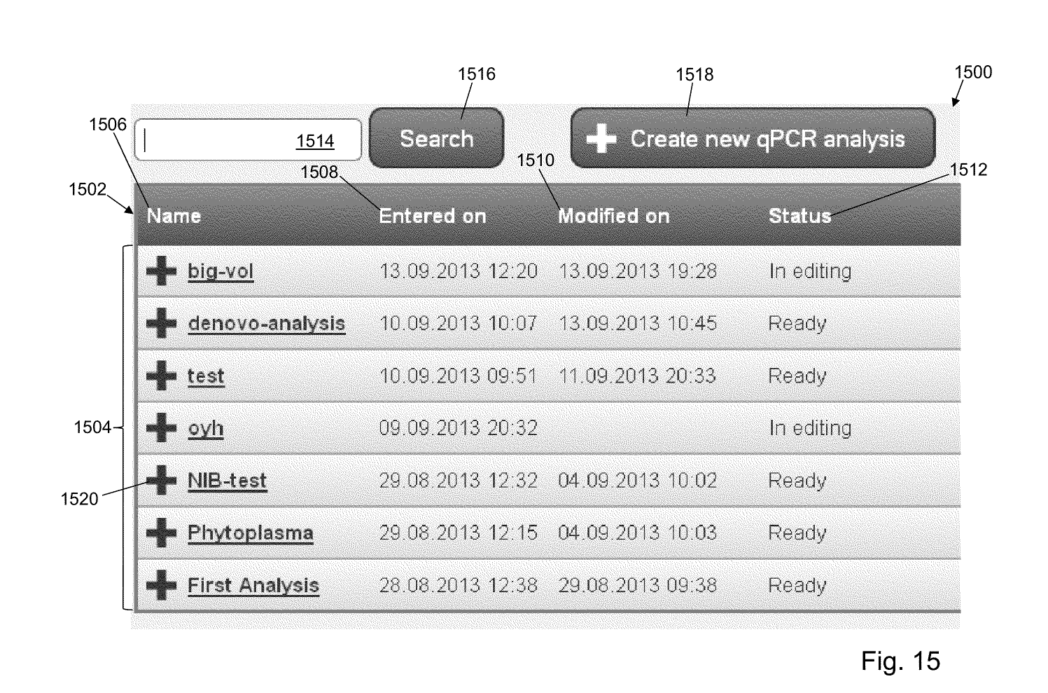

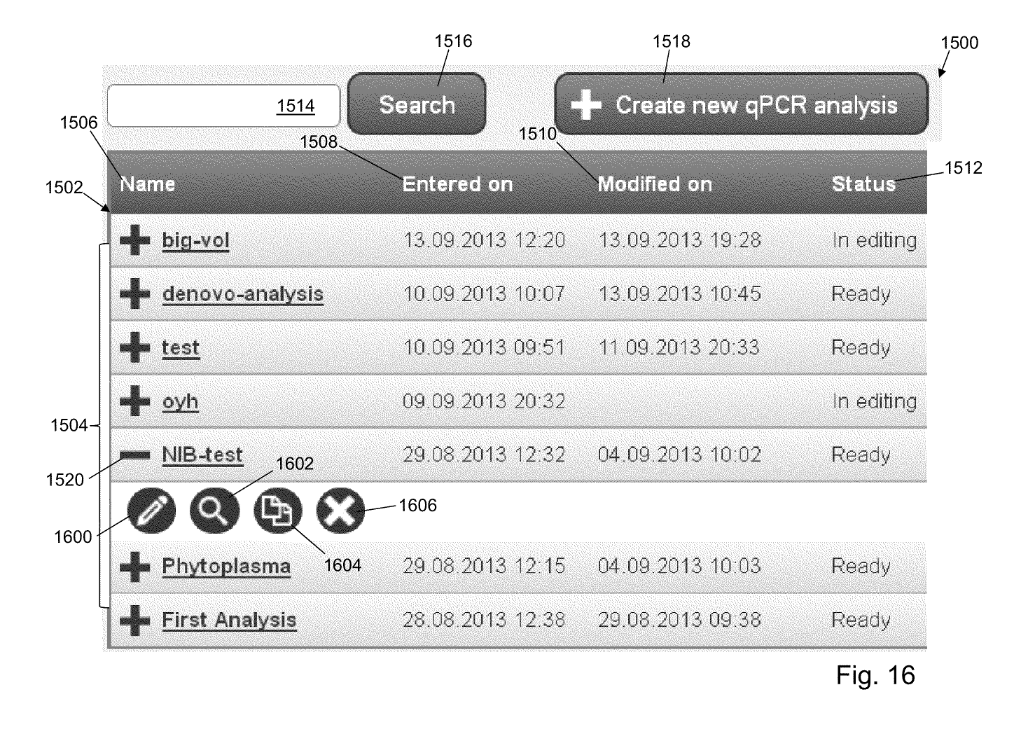

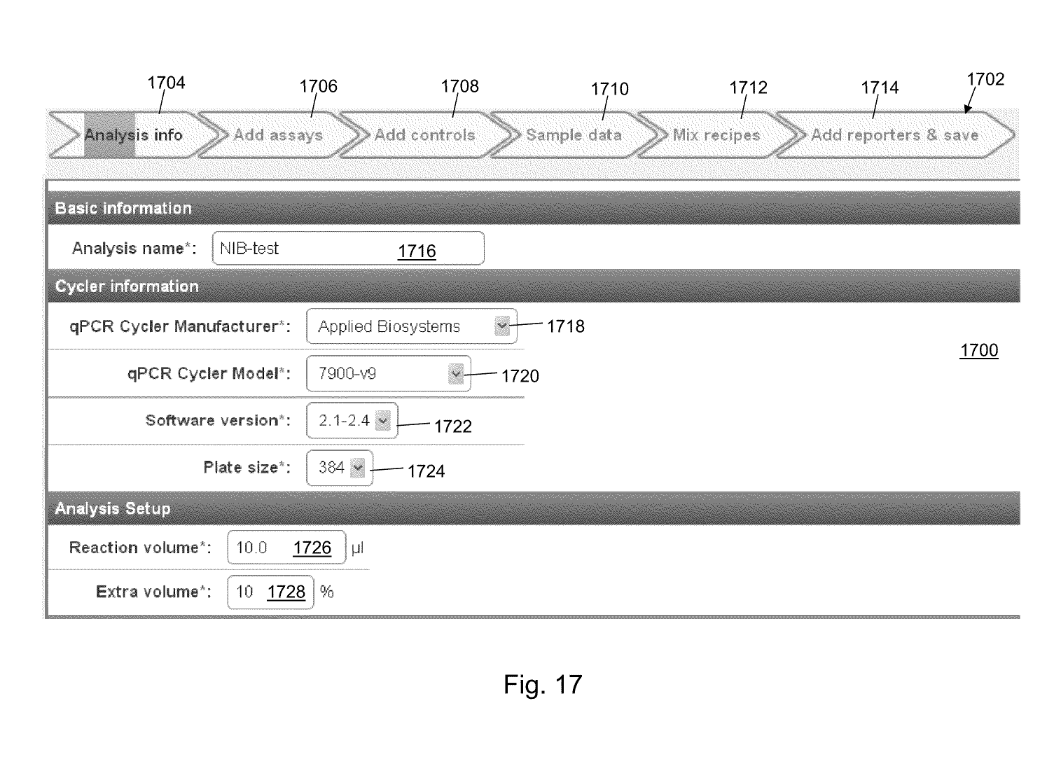

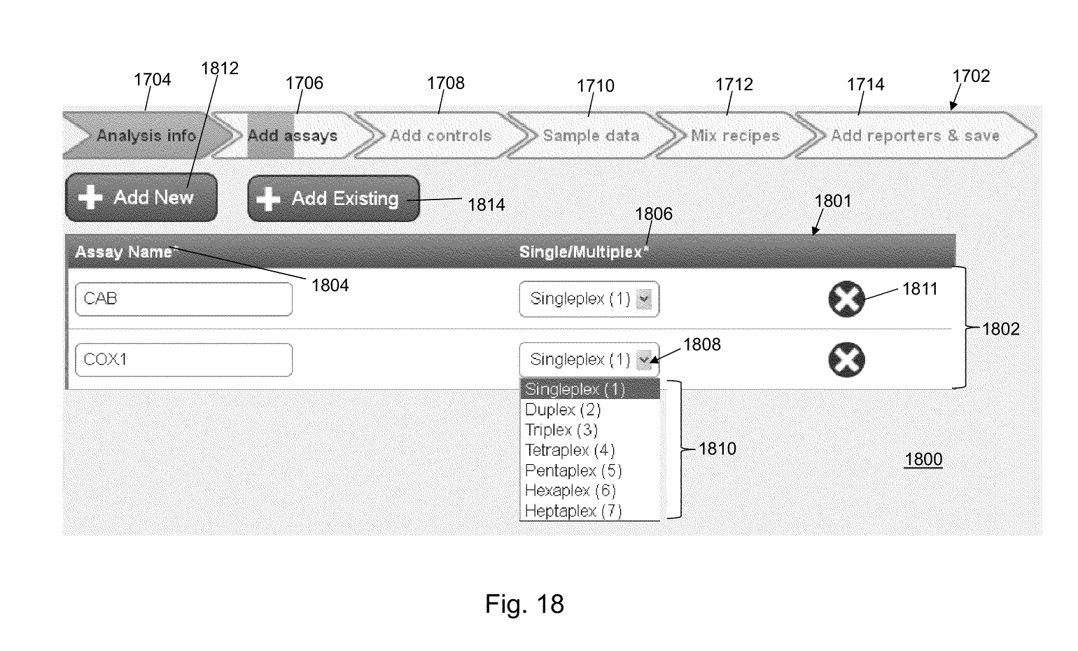

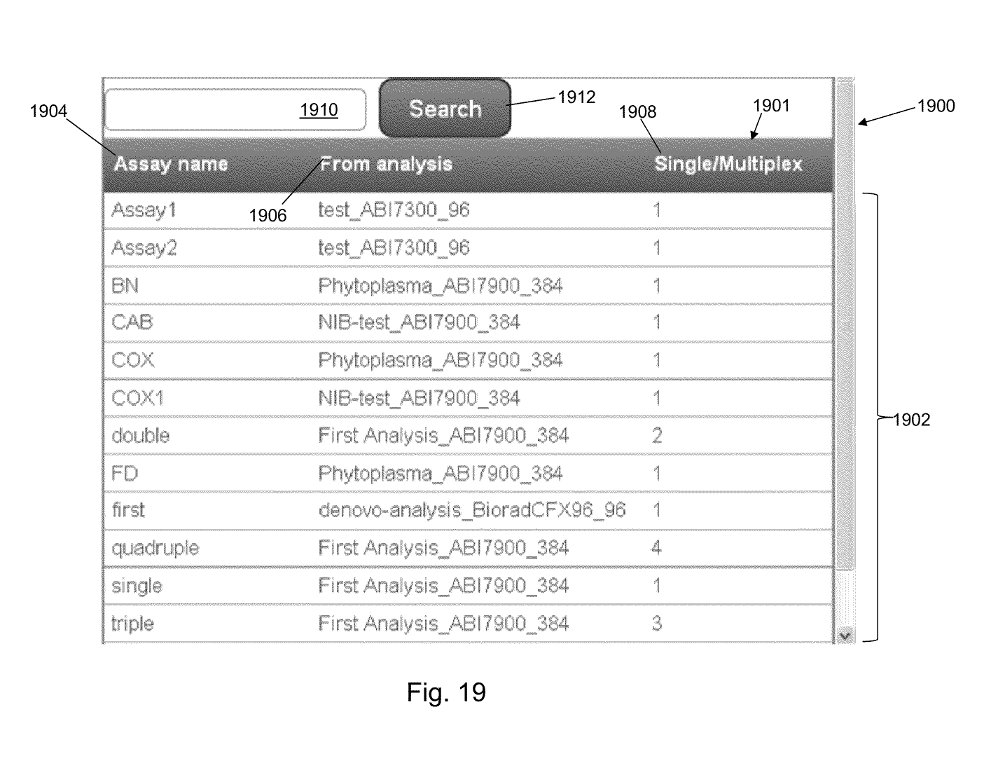

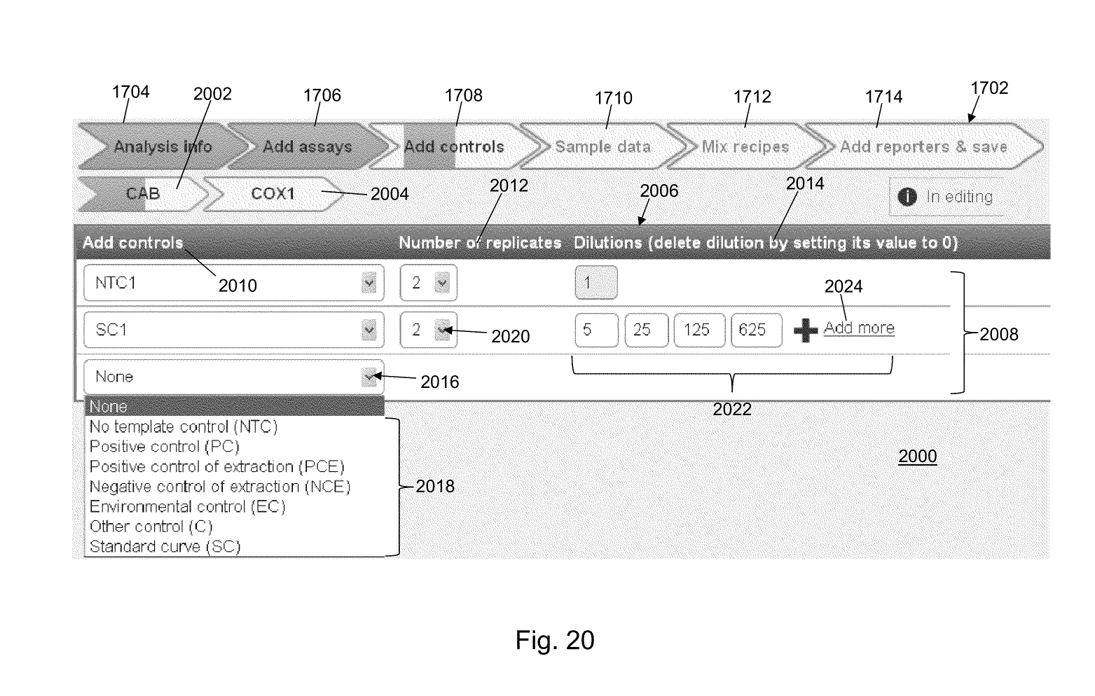

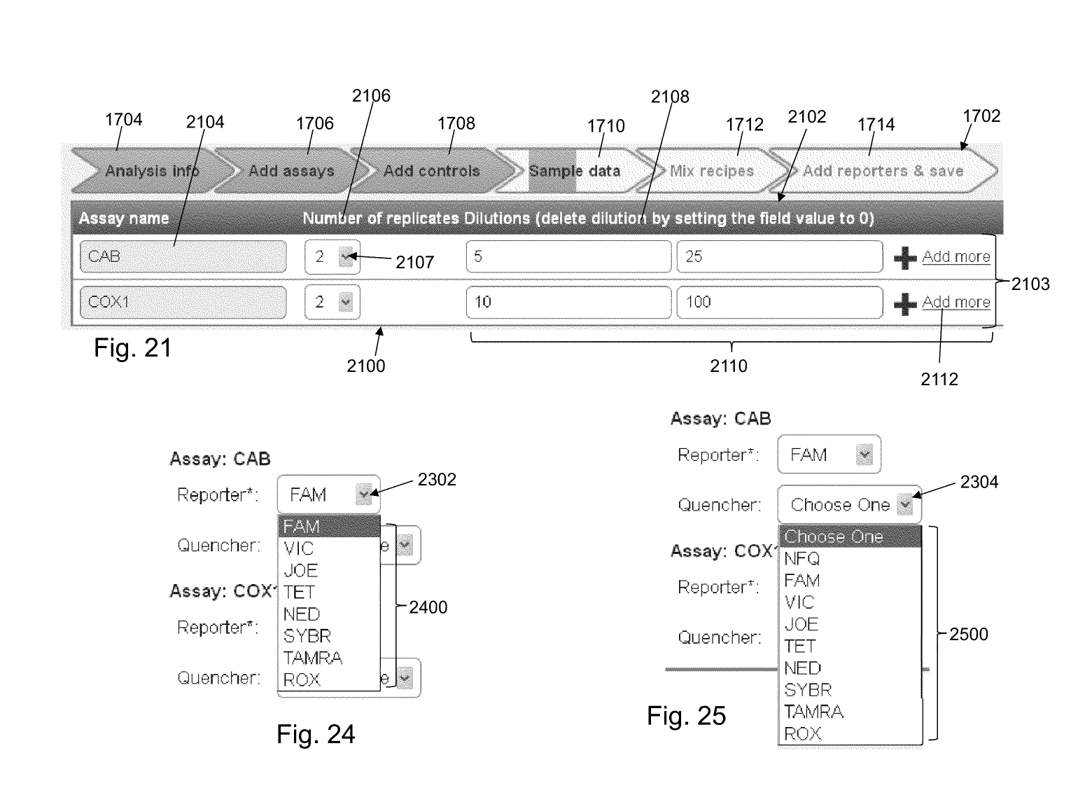

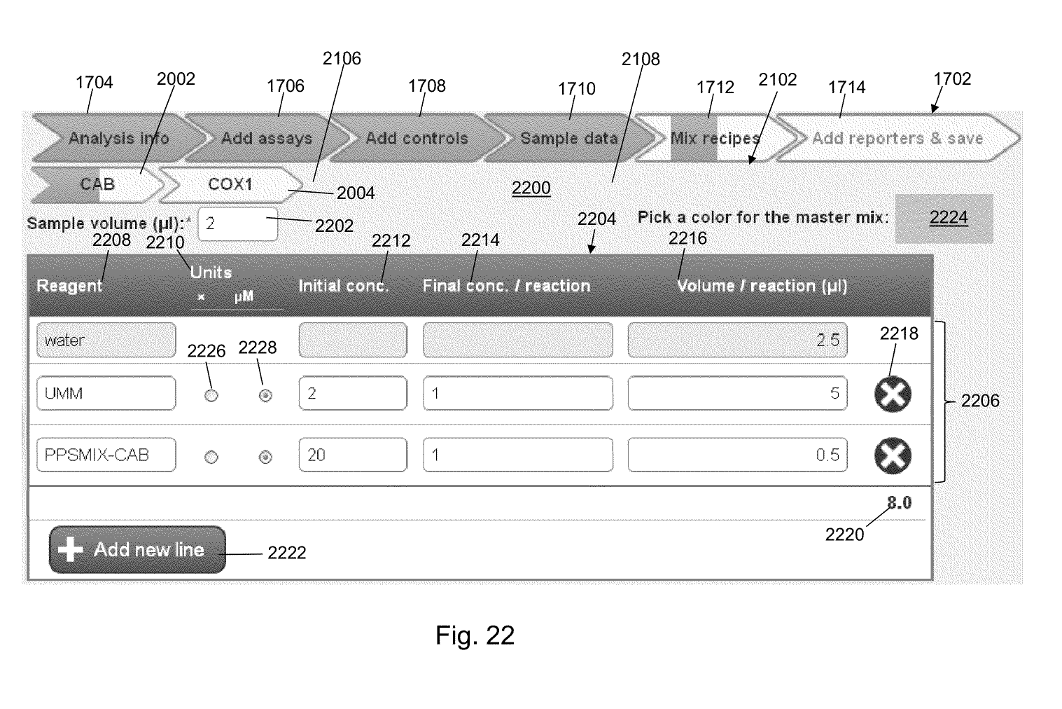

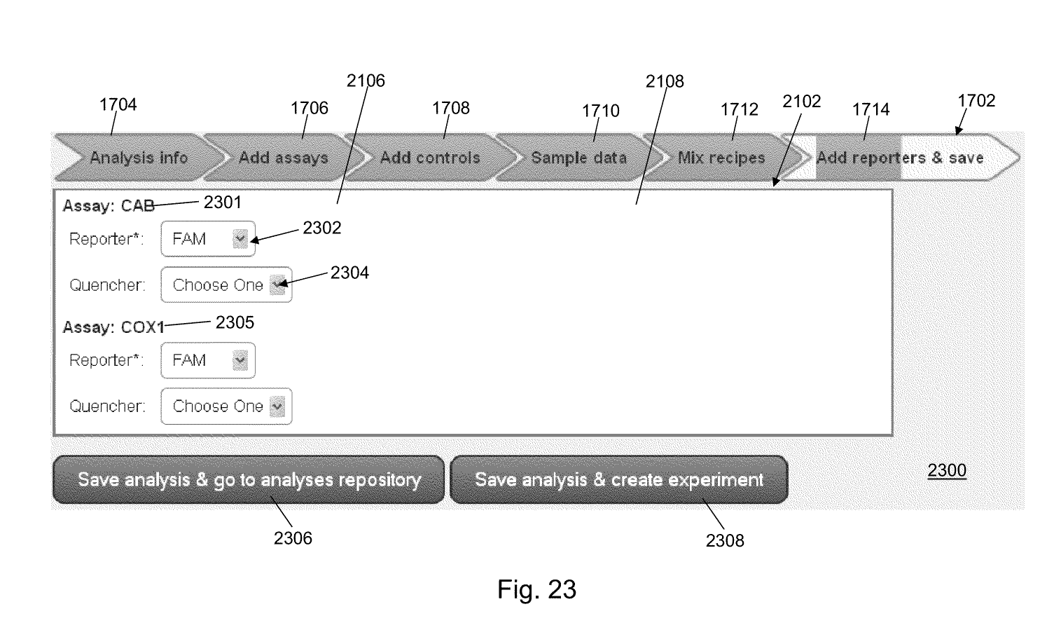

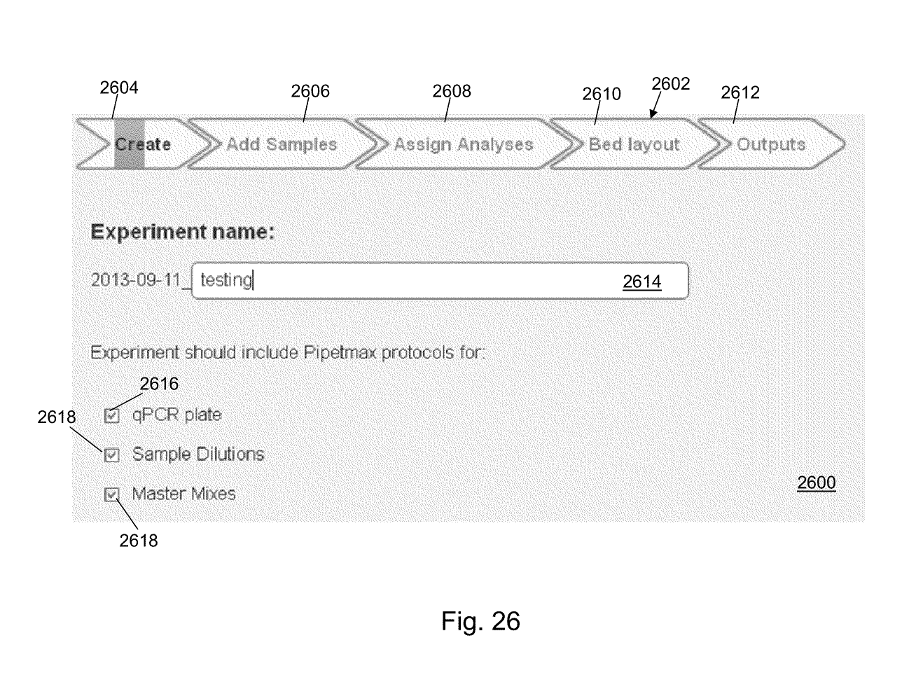

Referring to FIG. 14, additional example operations associated with protocol creation application 712 and/or second protocol creation application 810 are described. Additional, fewer, or different operations may be performed depending on the embodiment. The order of presentation of the operations of FIG. 14 is not intended to be limiting. A user can interact with one or more user interface windows presented to the user in display 720 or in second display 818 under control of protocol creation application 712 and/or second protocol creation application 810 independently or through the browser application in an order selectable by the user as understood by a person of skill in the art. Although some of the operational flows are presented in sequence, the various operations may be performed in various repetitions, concurrently (in parallel), and/or in other orders than those that are illustrated.

In an operation 1400, an indicator of user selection of manage qPCR analyses button 1006 is received. In an operation 1402, a manage qPCR analyses user interface window is presented. For example, with reference to FIG. 15, a manage qPCR analyses user interface window 1500 may include a qPCR analyses table 1502. qPCR analyses table 1502 may include a plurality of analyses rows 1504 with one row defined for each qPCR analysis previously created and saved by a user. qPCR analyses table 1502 may include a plurality of columns of information for each row of the plurality of analyses rows 1504. For example, qPCR analyses table 1502 may include a qPCR analysis name column 1506, a qPCR analysis creation time column 1508, a qPCR analysis modification time column 1510, and qPCR analysis creation status column 1512 for each row of the plurality of analyses rows 1504.

qPCR analysis name column 1506 includes a descriptive name for the qPCR analysis. qPCR analysis creation time column 1508 includes a creation date and time for the qPCR analysis. qPCR analysis modification time column 1510 includes a last modification date and time for the qPCR analysis. qPCR analysis creation status column 1512 includes a status for the qPCR analysis. For example, if the qPCR analysis is complete and ready to use, qPCR analysis creation status column 1512 may include “Ready” for the associated qPCR analysis. If the qPCR analysis is incomplete, qPCR analysis creation status column 1512 may include “In editing” for the associated qPCR analysis. Different users may access and edit one or more of the qPCR analyses listed in qPCR analyses table 1502 using a computing device of protocol creation system 104. As a result, another user may not be able to edit a qPCR analysis for which the status is “In editing”. An expand tab 1520 may be associated with each qPCR analysis listed in qPCR analyses table 1502.

qPCR analyses user interface window 1500 further may include a search window 1514, a search button 1516, and a create new analysis button 1518. The user may enter search text in search window 1514, for example, using keyboard 716 and select search button 1516 to search for the search text in qPCR analysis name column 1506. Using search button 1516, the user can quickly locate a qPCR analysis of interest.

With reference to FIG. 16, when a user selects expand tab 1520, an edit qPCR analysis button 1600, a view qPCR analysis button 1602, a copy qPCR analysis button 1604, and a delete qPCR analysis 1606 are presented below the qPCR analysis row associated with expand tab 1520. When an indicator is received indicating selection of edit qPCR analysis button 1600, the associated qPCR analysis is opened for editing. When an indicator is received indicating selection of view qPCR analysis button 1602, the associated qPCR analysis is opened for viewing. When an indicator is received indicating selection of copy qPCR analysis button 1604, a copy of the associated qPCR analysis is created and opened for editing. When an indicator is received indicating selection of delete qPCR analysis 1606, the associated qPCR analysis is deleted and the associated row removed from qPCR analyses table 1502.

With continuing reference to FIG. 14, in an operation 1404, an indicator of user selection of a qPCR analysis to edit is received. For example, the user may select either edit qPCR analysis button 1600 or copy qPCR analysis button 1604 and an indicator of the associated qPCR analysis is received. In an operation 1405, an edit user qPCR analysis interface window is presented. For example, with reference to FIG. 17, a first qPCR analysis interface window 1700 is presented.

As another option, with continuing reference to FIG. 14, in an operation 1406, an indicator of user selection of create new analysis button 1518 is received. In an operation 1407, an edit user qPCR analysis interface window is presented similar to that shown with reference to FIG. 17 except that the fields are empty as understood by a person of skill in the art.

First qPCR analysis interface window 1700 may include an analysis creation workflow status bar 1702 that includes an analysis information status indicator 1704, an add assays status indicator 1706, an add controls status indicator 1708, an add sample data status indicator 1710, an add mix status indicator 1712, and an add reporter status indicator 1714. Whether each indicator 1704, 1706, 1708, 1710, 1712, 1714 is not filled, partially filled, or fully filled may indicate whether or not the definition of that parameter for the qPCR analysis is not started, in process, or complete, respectively.

First qPCR analysis interface window 1700 further may include an analysis name window 1716, a qPCR cycler manufacturer selector 1718, a qPCR cycler model selector 1720, a qPCR cycler software version number selector 1722, a qPCR cycler plate size selector 1724, a reaction volume window 1726, and an extra volume window 1728. The user may enter an analysis name in analysis name window 1716, for example, using keyboard 716. The analysis name may be displayed in qPCR analysis name column 1506 after creating and saving the qPCR analysis. In an illustrative embodiment, each analysis name may automatically receive an additional tag composed of an identifier for the selected qPCR cycler manufacturer and a plate size indicator for the selected qPCR cycler manufacturer in the form: “MyFirstAnalysis_ABI7900_{—}384”. This naming structure makes a particular analysis easier to find when assigning an analysis to samples in an experiment workflow especially if a laboratory has different qPCR cyclers.

qPCR cycler manufacturer selector 1718 includes a list of the qPCR cycler manufacturers listed in manufacturer name column 1312 of qPCR cycler table 1308. qPCR cycler model selector 1720 includes a list of the model type identifiers listed in model type column 1314 of qPCR cycler table 1308 for the qPCR cycler manufacturer selected using qPCR cycler manufacturer selector 1718. qPCR cycler software version number selector 1722 includes a list of the software version identifiers listed in software version column 1316 of qPCR cycler table 1308 for the qPCR cycler manufacturer selected using qPCR cycler manufacturer selector 1718. qPCR cycler plate size selector 1720 includes a list of the plate sizes listed in plate size column 1318 of qPCR cycler table 1308 for the qPCR cycler manufacturer selected using qPCR cycler manufacturer selector 1718.

The user may enter a reaction volume in reaction volume window 1726, for example, using keyboard 716. The reaction volume in a qPCR plate may be defined as the sum of a reaction master mix volume and a sample volume.

The user may enter an extra volume in extra volume window 1728, for example, using keyboard 716. The extra volume may be defined as a percentage of extra volume for all source components, such as master mixes, reagents that are used to prepare master mixes, sample used for sample dilutions, etc. The extra volume may compensate for pipetting losses that occur during pipetting of a qPCR plate, sample dilutions, and master mixes using liquid handler 200. The extra volume may be automatically taken into account when calculating reagents for master mixes, samples and water for sample dilutions, and master mixes and sample dilutions for the qPCR Plate. The extra volume may vary from laboratory to laboratory and from analyses to analyses because it depends on environmental conditions and on the number of transfer operations in the analysis.

With continuing reference to FIG. 14, in an operation 1408, analysis information is received. For example, the user may select a next button presented in first qPCR analysis interface window 1700, which results in saving the analysis information from first qPCR analysis interface window 1700, and in presentation of a second qPCR analysis interface window 1800 shown with reference to FIG. 18 in accordance with an illustrative embodiment. Second qPCR analysis interface window 1800 may include analysis creation workflow status bar 1702 updated to reflect the current workflow status.

Second qPCR analysis interface window 1800 further may include an assay table 1801. Assay table 1801 may include a plurality of assay rows 1802 with one row defined for each assay included in the qPCR analysis. Assay table 1801 may include a plurality of columns of information for each row of the plurality of assay rows 1802. For example, assay table 1801 may include an assay name column 1804 and a single/multiplex column 1806 for each row of the plurality of assay rows 1802. Assay name column 1804 includes a descriptive name for the assay. Single/multiplex column 1806 includes a single/multiplex selector 1808. Selection of single/multiplex selector 1808 results in presentation of a plurality of single/multiplex selectors 1810. For example, the plurality of single/multiplex selectors 1810 may include “singleplex”, “duplex”, “triplex”, “tetraplex”, “pentaplex”, “hexaplex”, “heptaplex”, etc. Singleplex and multiplex assays can be combined in the same analysis.

An assay delete button 1811 may be associated with each assay in assay table 1801. When an indicator is received indicating selection of assay delete button 1811, the associated assay is deleted and the associated row removed from assay table 1801.

Second qPCR analysis interface window 1800 further may include an add new assay button 1812 and an add existing assay button 1814. When an indicator is received indicating selection of add new assay button 1812, a new row is added to the end of assay table 1801. When an indicator is received indicating selection of add existing assay button 1814, an assay selector interface window 1900, shown with reference to FIG. 19 in accordance with an illustrative embodiment, is presented.

Assay selector interface window 1900 may include an assay list table 1901. Assay list table 1901 may include a plurality of assay rows 1902 with one row defined for each assay previously defined. Assay list table 1901 may include a plurality of columns of information for each row of the plurality of assay rows 1902. For example, assay list table 1901 may include an assay name column 1904, an analysis name column 1906, and a single/multiplex column 1908 for each row of the plurality of assay rows 1902. Assay name column 1904 includes the descriptive name for the assay that is also listed in assay name column 1804 when the assay is selected. Analysis name column 1906 includes the descriptive name for the analysis in which the assay was first used and that is listed in analysis name window 1716. Single/multiplex column 1908 includes the value associated with the single/multiplex selector 1808 selected and listed in single/multiplex column 1806 when the assay is selected. For example, the plurality of single/multiplex selectors 1810 may include “1”, “2”, “3”, “4”, “5”, “6”, “7”, etc.

Assay selector interface window 1900 further may include a search window 1910 and a search button 1912. The user may enter search text in search window 1910, for example, using keyboard 716 and select search button 1912 to search for the search text in assay name column 1904. Using search button 1912, the user can quickly locate an assay of interest.

With continuing reference to FIG. 14, in an operation 1410, assay information is received. For example, the user may select a next button presented in second qPCR analysis interface window 1800, which results in saving the assay information from second qPCR analysis interface window 1800, and in presentation of a third qPCR analysis interface window 2000 shown with reference to FIG. 20 in accordance with an illustrative embodiment. Third qPCR analysis interface window 2000 may include analysis creation workflow status bar 1702 updated to reflect the current workflow status.

Third qPCR analysis interface window 2000 further may include a first assay identifier 2002, a second assay identifier 2004, and a control table 2006. An assay identifier is included for each assay listed in assay table 1801. The assay identifier includes the descriptive name for the assay listed in assay name column 1904 for the respective assay. Whether the assay identifier is not filled, partially filled, or fully filled may indicate whether or not the control definition of that assay is not started, in process, or complete, respectively. As an example, first assay identifier 2002 includes “CAB” and second assay identifier 2004 includes “COX1”. First assay identifier is partially filled because the control definition of the first assay is in process. Second assay identifier 2004 is not filled because the control definition of that assay is not started.

Control table 2006 may include a plurality of control rows 2008 with one row defined for each control defined for the assay indicated by first assay identifier 2002. Control table 2006 may include a plurality of columns of information for each row of the plurality of control rows 2008. For example, control table 2006 may include a control name column 2010, a number of replicates column 2012, and a dilutions column 2014 for each row of the plurality of control rows 2008. Control name column 2010 includes a control selector 2016 for the control. Selection of control selector 2016 results in presentation of a plurality of control selectors 2018. For example, the plurality of control selectors 2018 may include “none”, “no template control (NTC)”, “positive control (PC)”, “positive control of extraction (PCE)”, “negative control of extraction (NCE)”, “environmental control (EC)”, “other control (C)”, “standard curve (SC)”, etc. In an illustrative embodiment, when a selector of the plurality of control selectors 2018 is selected, the name indicated in control name column 2010 includes an acronym for the control appended with an incrementing number for each time the control is used on the assay. For example, control name column 2010 includes the acronym “NTC1” in a first row based on a first selection of “no template control (NTC)” from the plurality of control selectors 2018 and the acronym “CC1” in a second row based on a first selection of “standard curve (SC)” from the plurality of control selectors 2018. To delete a control, “none” can be selected using control selector 2016.

No template control (NTC) indicates possible contamination of reaction mixture and contaminations introduced during pipetting using liquid handler 200. Positive control (PC) indicates whether all reagents in the master mix work properly. Positive control of extraction (PCE) indicates whether the extraction procedure went well. If using an extraction code with samples, PCE is linked to it. Negative control of extraction (NCE) indicates possible contamination during the NA extraction step. In these samples, the sample material may be replaced with water or buffer, and the samples are processed along with other real samples. If using an extraction code with samples, NCE is linked to it. Environmental control (EC) indicates contamination from environment/laboratory where NA extraction takes place. The EC sample usually starts as an empty opened tube that is present where the NA extraction is performed and goes through the procedures along with the rest of the real samples. If using an extraction code with samples, EC is linked to it. Standard curve (SC) indicates an add dilution series that can be used for absolute or relative calculation during qPCR data analysis. Other control (C) indicates a general control.

Number of replicates column 2012 includes a number of replicates selector 2020. Selection of number of replicates selector 2020 results in presentation of a series of numbers from which the user may choose. For example, the number of replicates selector 2020 may include “1”, “2”, “3”, “4”, “5”, “6”, “7”, etc.

Dilutions column 2014 includes one or more dilution windows 2022. A dilution amount is entered in each of the one or more dilution windows 2022. Another dilution window can be added to the one or more dilution windows 2022 by selection of add dilution button 2024. A dilution window can be deleted by entering the value zero in the dilution window to remove the dilution window from the one or more dilution windows 2022. In an illustrative embodiment, it is not possible to enter dilutions when the plurality of control selectors 2018 is “no template control (NTC)” because the template is usually replaced by water.

With continuing reference to FIG. 14, in an operation 1412, controls information is received for each assay defined in assay interface window 1900. For example, the user may select a next button presented in third qPCR analysis interface window 2000, which results in saving the assay information from third qPCR analysis interface window 2000, and in presentation of a fourth qPCR analysis interface window 2100 shown with reference to FIG. 21 in accordance with an illustrative embodiment. Fourth qPCR analysis interface window 2100 may include analysis creation workflow status bar 1702 updated to reflect the current workflow status.

Fourth qPCR analysis interface window 2100 further may include an assay table 2102. Assay table 2102 may include a plurality of assay rows 2103 with one row defined for each assay listed in assay table 1801. For example, assay table 2102 may include an assay name column 2104, a number of replicates column 2106, and a dilutions column 2108 for each row of the plurality of assay rows 2103. Assay name column 2104 includes the descriptive name for the assay listed in assay name column 1904 for the respective assay.

Number of replicates column 2106 includes a number of replicates selector 2107. Selection of number of replicates selector 2107 results in presentation of a series of numbers from which the user may choose. For example, the number of replicates selector 2107 may include “1”, “2”, “3”, “4”, “5”, “6”, “7”, etc. The selector value selected using number of replicates selector 2107 indicates the number of replicate wells on a qPCR plate for a single sample.

Dilutions column 2108 includes one or more dilution windows 2110. A dilution amount is entered in each of the one or more dilution windows 2110. Another dilution window can be added to the one or more dilution windows 2110 by selection of add dilution button 2112. A dilution window can be deleted by entering the value zero in the dilution window to remove the dilution window from the one or more dilution windows 2110.

With continuing reference to FIG. 14, in an operation 1414, sample information is received for each assay defined in assay interface window 1900. For example, the user may select a next button presented in fourth qPCR analysis interface window 2100, which results in saving the sample information from fourth qPCR analysis interface window 2100, and in presentation of a fifth qPCR analysis interface window 2200 shown with reference to FIG. 22 in accordance with an illustrative embodiment. Fifth qPCR analysis interface window 2200 may include analysis creation workflow status bar 1702 updated to reflect the current workflow status.

Fifth qPCR analysis interface window 2200 further may include first assay identifier 2002, second assay identifier 2004, a sample volume window 2202, and a mix table 2204. The composition of master mixes for a single well for each assay may be defined using fifth qPCR analysis interface window 2200 including a sample volume, water, primers, probe, PCR buffers, ready-to-use mixtures, etc. The user may enter the sample volume for one qPCR reaction in sample volume window 2202, for example, using keyboard 716.

Mix table 2204 may include a plurality of reagent rows 2206 with one row defined for each reagent defined for the assay indicated by first assay identifier 2002. Mix table 2204 may include a plurality of columns of information for each row of the plurality of reagent rows 2206. For example, mix table 2204 may include a reagent name column 2208, a units column 2210, an initial concentration column 2212, a final concentration per reaction column 2214, and a volume per reaction column 2216 for each row of the plurality of reagent rows 2206. Reagent name column 2208 includes a text window in which the user enters a reagent name. In an illustrative embodiment, a first reagent listed is automatically water, and the user can enter a value in volume per reaction column 2216.

The units column 2210 includes a first radio button 2226 and a second radio button 2228. First radio button 2226 is selected when a pre-concentrated solution is used. Second radio button 2228 is selected to define the μM (micromole) for the associated reagent.

Two out of three values are entered in text boxes associated with each of initial concentration column 2212, final concentration per reaction column 2214, and volume per reaction column 2216. The remaining third value is calculated automatically. As an example, for a “Reagent 1”, the initial concentration of the stock solution is entered in initial concentration column 2212, and the final concentration of Reagent 1 in the reaction mixture in the well after adding the template is entered in μM (e.g. 0.9 μM=900 nM) in final concentration per reaction column 2214. The value entered in volume per reaction column 2216 is calculated and entered automatically. Second radio button 2228 is selected to indicate the concentration is defined in μM. If reagents with the same name in reagent name column 2208 are used in different assays, the reagents are pooled and treated as a single reagent source during preparation of the pipetting protocol for liquid handler 200.

A reagent delete button 2218 may be associated with each reagent in mix table 2204. When an indicator is received indicating selection of reagent delete button 2218, the associated reagent is deleted and the associated row removed from mix table 2204.

Fifth qPCR analysis interface window 2200 further may include a mix total volume 2220 per reaction that is calculated automatically based on the entries in mix table 2204. Fifth qPCR analysis interface window 2200 further may include an add new reagent button 2222, which add a new line to mix table 2204.

Fifth qPCR analysis interface window 2200 further may include a master mix color selector 2224. Selection of master mix color selector 2224 causes presentation of a color palette from which the user may assign a color to represent the assay in the pipetting scheme. Different colors may be used for different assays to easily identify the assay locations on work bed 206.

With continuing reference to FIG. 14, in an operation 1416, mix information is received for each assay defined in assay interface window 1900. For example, the user may select a next button presented in fifth qPCR analysis interface window 2200, which results in saving the sample information from fifth qPCR analysis interface window 2200, and in presentation of a sixth qPCR analysis interface window 2300 shown with reference to FIG. 23 in accordance with an illustrative embodiment. Sixth qPCR analysis interface window 2300 may include analysis creation workflow status bar 1702 updated to reflect the current workflow status.

Sixth qPCR analysis interface window 2300 further may include a first assay identifier 2301, a second assay identifier 2305, a reporter selector 2302, and a quencher selector 2304. An assay identifier is included for each assay listed in assay table 1801. The assay identifier includes the descriptive name for the assay listed in assay name column 1904 for the respective assay. As an example, first assay identifier 2301 includes “CAB” and second assay identifier 2305 includes “COX1”.

Selection of reporter selector 2302 results in presentation of a plurality of reporter selectors 2400 as shown with reference to FIG. 24. For example, the plurality of reporter selectors 2400 may include “FAM”, “VIC”, “JOE”, “TET”, “NED”, “SYBR”, “TAMRA”, “ROX”, etc. As understood by a person of skill in the art, reporter selectors 2400 are abbreviated identifiers that describe different fluorescent dyes used to label probes or DNA molecules in general. Selection of quencher selector 2304 results in presentation of a plurality of quencher selectors 2500 as shown with reference to FIG. 25. For example, the plurality of quencher selectors 2500 may include “NFQ”, “FAM”, “VIC”, “JOE”, “TET”, “NED”, “SYBR”, “TAMRA”, “ROX”, etc. As understood by a person of skill in the art, quencher selectors 2500 are abbreviated identifiers that describe different molecules (quenchers) that absorb excitation energy from a fluorescent dye (fluorophore) and dissipate the energy as heat (dark quenchers) or re-emit much of this energy as light (fluorescent quenchers). They are used in probes to quench the fluorescent light from reporters.

With continuing reference to FIG. 23, sixth qPCR analysis interface window 2300 further may include a first save button 2306 and a second save button 2308. With continuing reference to FIG. 14, in an operation 1418, reporter information is received for each assay defined in assay interface window 1900. In an operation 1420, the edited/created qPCR analysis is stored, for example, in database 714 or on computer-readable medium 708. For example, selection of first save button 2306 results in saving the analyses and causing presentation of manage qPCR analyses user interface window 1500 with qPCR analyses table 1502 updated to include the new analysis. qPCR analysis name column 1506 includes the name entered in analysis name window 1716. qPCR analysis creation time column 1508 includes the current time if copy qPCR analysis button 1604 or create new analysis button 1518 was selected. qPCR analysis modification time column 1510 includes the current time if edit qPCR analysis button 1600 was selected. The status in analysis creation status column 1512 is set to “Ready” and the analysis is ready for use in creating an experiment.

Selection of second save button 2308 results in saving the analyses and causing presentation of a create experiment user interface window 2600 shown with reference to FIG. 26 in accordance with an illustrative embodiment.

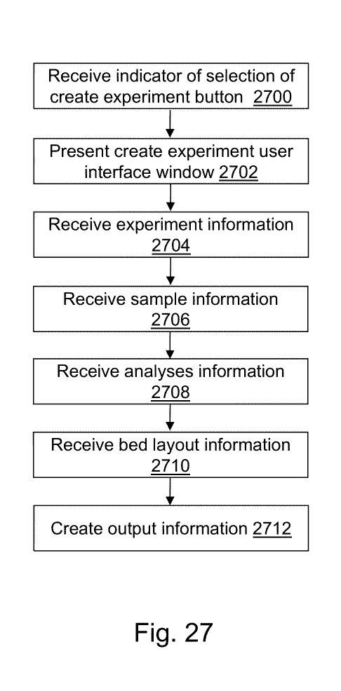

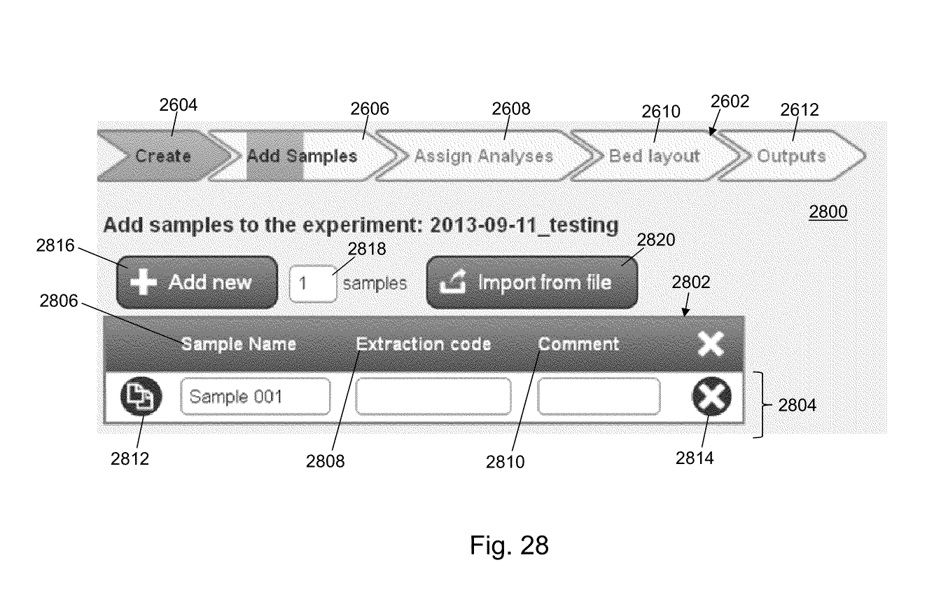

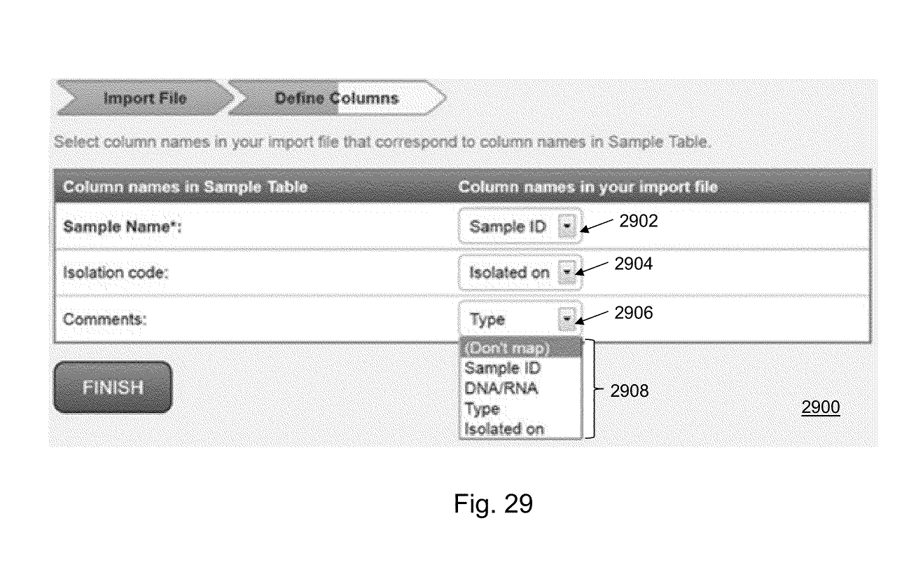

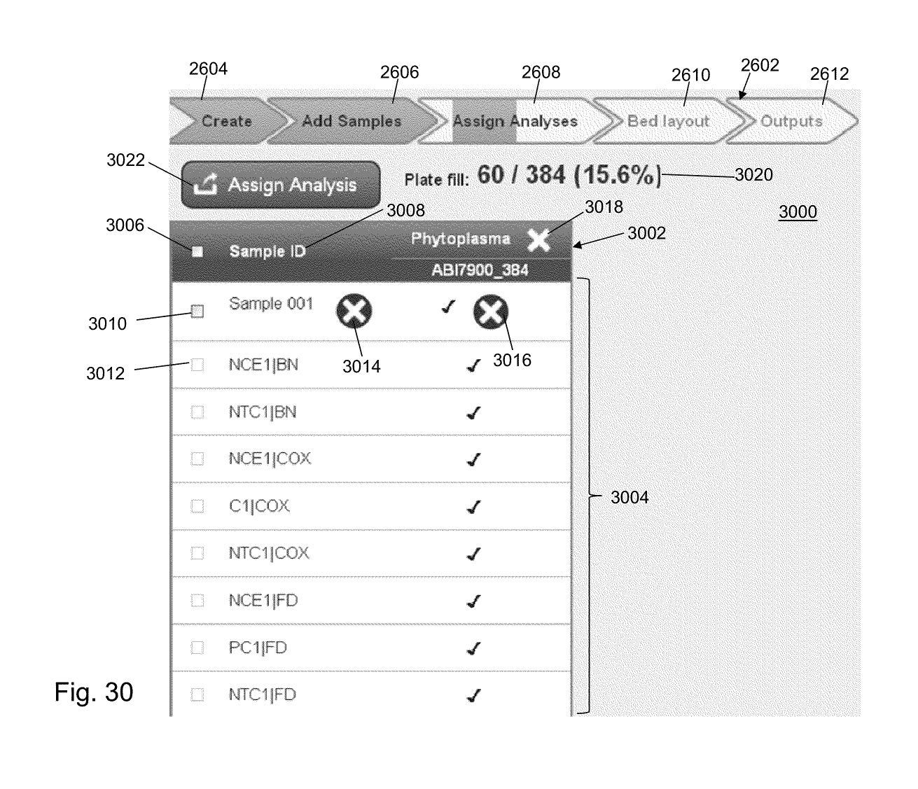

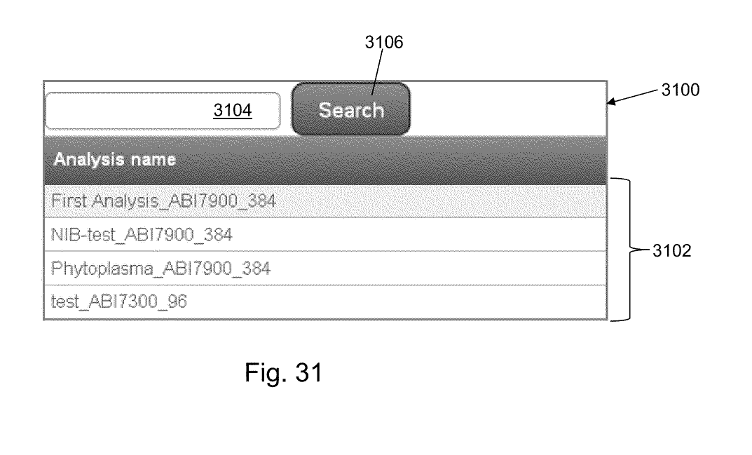

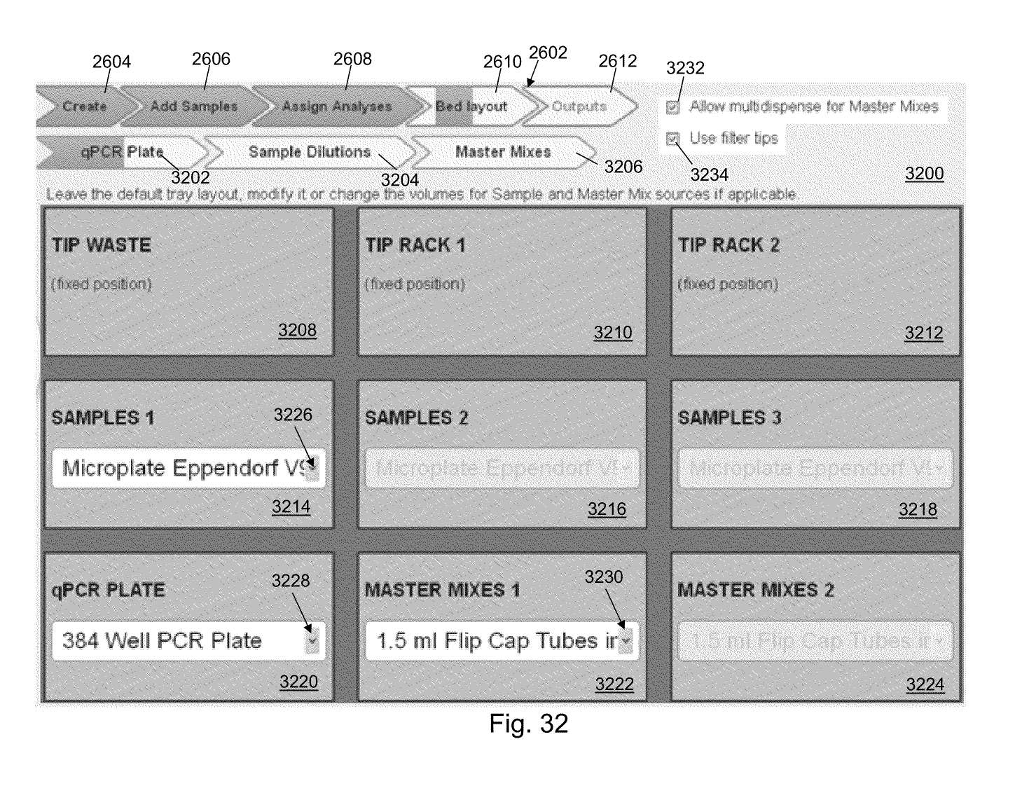

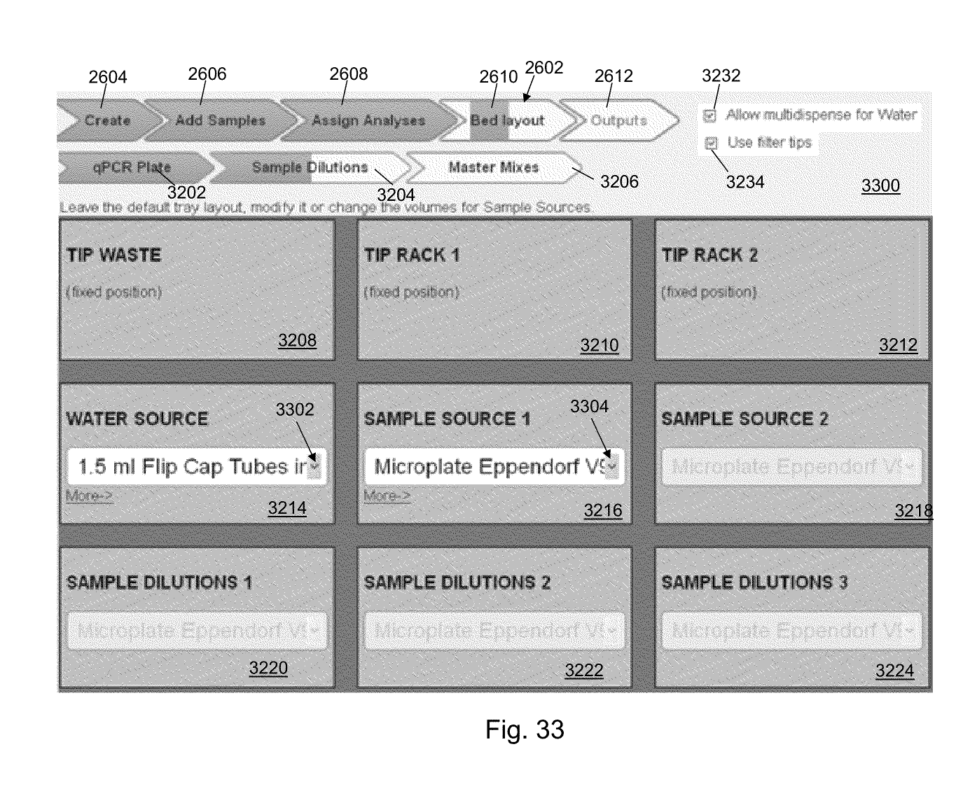

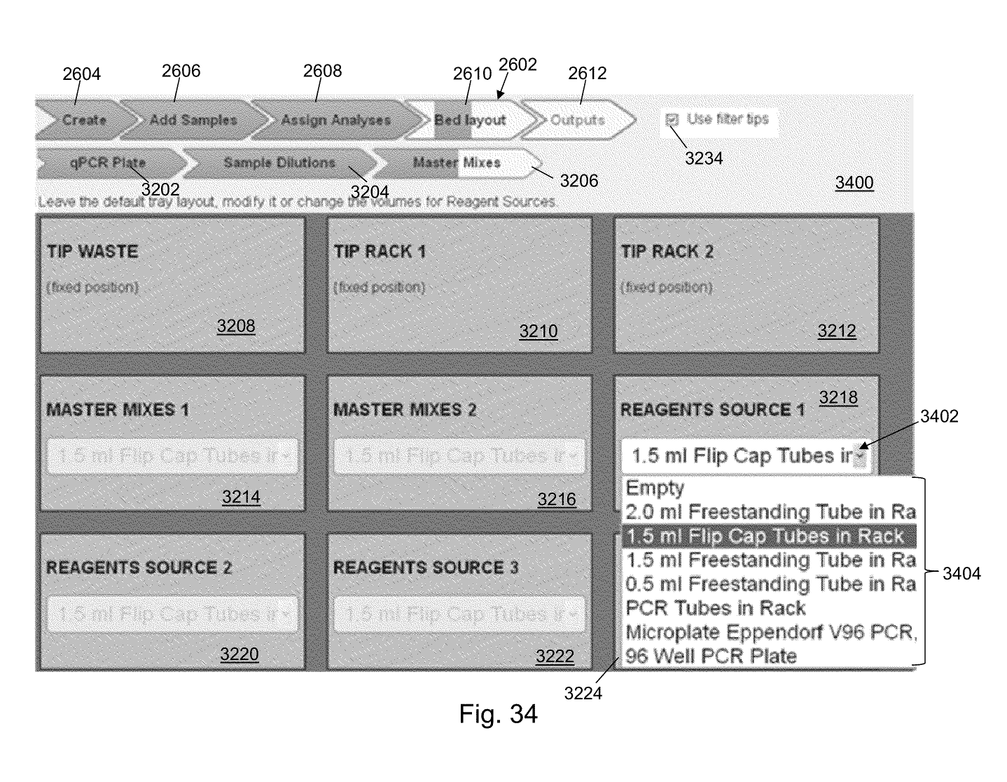

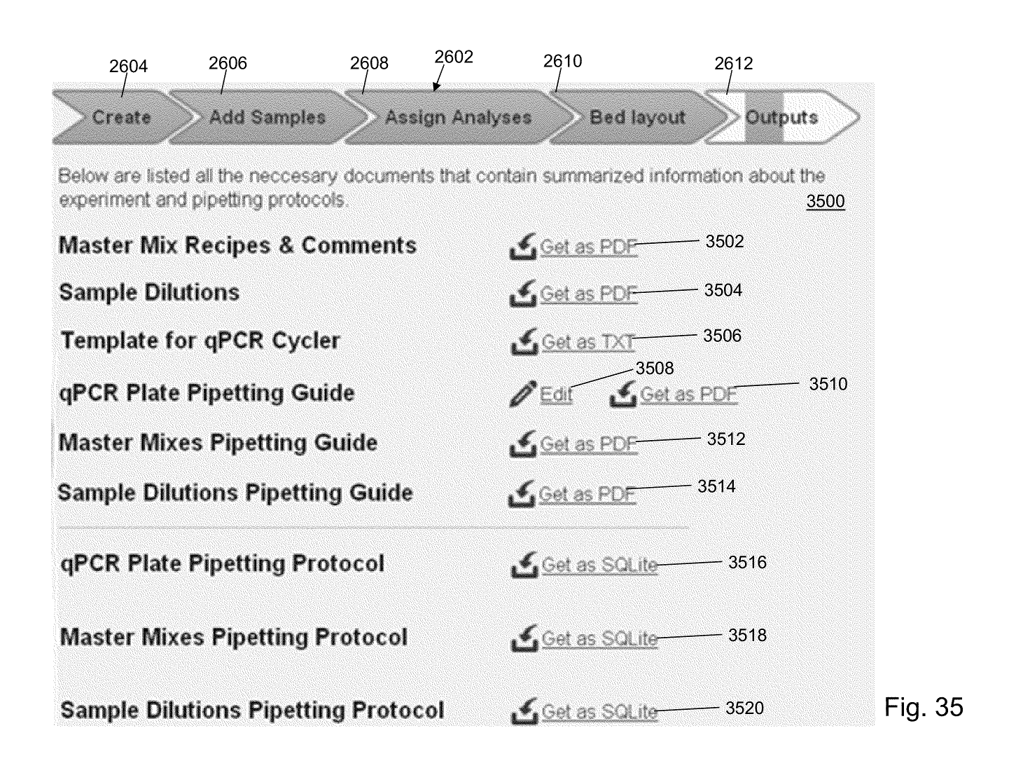

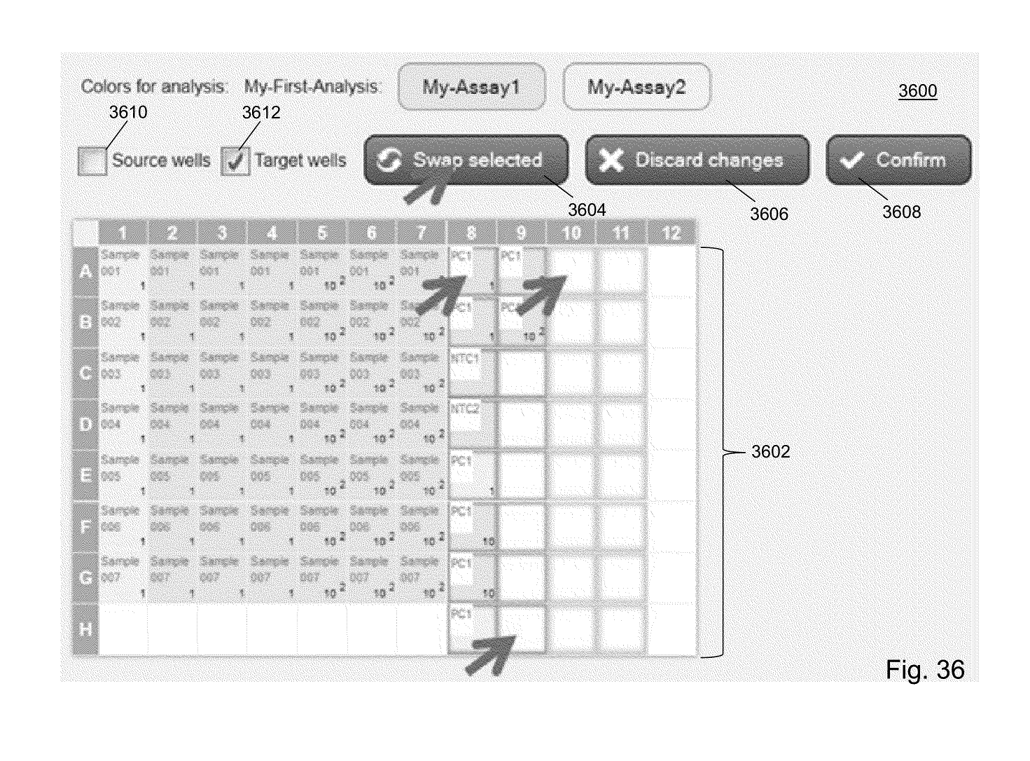

Referring to FIG. 27, additional example operations associated with protocol creation application 712 and/or second protocol creation application 810 are described. Additional, fewer, or different operations may be performed depending on the embodiment. The order of presentation of the operations of FIG. 27 is not intended to be limiting. A user can interact with one or more user interface windows presented to the user in display 720 or in second display 818 under control of protocol creation application 712 and/or second protocol creation application 810 independently or through the browser application in an order selectable by the user as understood by a person of skill in the art. Although some of the operational flows are presented in sequence, the various operations may be performed in various repetitions, concurrently (in parallel), and/or in other orders than those that are illustrated.

In an operation 2700, an indicator of user selection of create qPCR experiment button 1008 is received. In an operation 2702, create experiment user interface window 2600 is presented. For example, with reference to FIG. 26, create experiment user interface window 2600 may include an experiment status indicator bar 2602. Experiment status indicator bar 2602 may include a create experiment status indicator 2604, an add samples status indicator 2606, an assign analyses status indicator 2608, a bed layout status indicator 2610, and an output status indicator 2612. Whether each indicator 2604, 2606, 2608, 2610, 2612 is not filled, partially filled, or fully filled may indicate whether or not the definition of that parameter for the experiment is not started, in process, or complete, respectively.

Create experiment user interface window 2600 further may include an experiment name window 2614, a qPCR plate check box 2616, a sample dilutions check box 2618, and a master mixes check box 2620. In an illustrative embodiment, the experiment name is text entered by the user in experiment name window 2614 prefixed by an automatically generated date. qPCR plate check box 2616 is checked if a protocol for liquid handler 200 is to be generated for a qPCR plate. Sample dilutions check box 2618 is checked if a protocol for liquid handler 200 is to be generated for sample dilutions. Master mixes check box 2620 is checked if a protocol for liquid handler 200 is to be generated for master mixes. One or more of qPCR plate check box 2616, sample dilutions check box 2618, and master mixes check box 2620 may be selected.

With continuing reference to FIG. 27, in an operation 2704, experiment information is received. For example, the user may select a next button presented in create experiment user interface window 2600, which results in saving the experiment information from create experiment user interface window 2600, and in presentation of a first experiment interface window 2800 shown with reference to FIG. 28 in accordance with an illustrative embodiment. First experiment interface window 2800 may include experiment status indicator bar 2602 updated to reflect the current workflow status.

First experiment interface window 2800 further may include a sample table 2802. Sample table 2802 may include a plurality of sample rows 2804 with one row defined for each sample defined for the experiment. Sample table 2802 may include a plurality of columns of information for each row of the plurality of sample rows 2804. For example, sample table 2802 may include a sample name column 2806, an extraction code column 2808, and a comment column 2810 for each row of the plurality of sample rows 2804. Sample name column 2806 includes a text window in which the user enters a sample name that is unique. Extraction code column 2808 includes a text window in which the user enters a date or code of a particular NA extraction in which the particular sample was extracted. Certain controls (NCE, PCE, OE) are related to NA extraction batch. The value entered in the text window may also be used to mark these controls for every NA extraction. Samples isolated in the same batch may have the same extraction code, including negative control of extraction, positive control of extraction, and environment control, which are automatically added to the experiment and connected to the samples if defined in the analysis. Comment column 2810 includes a text window in which the user enters any information to add about the sample. The comment may be shown in an output.

First experiment interface window 2800 further may include a sample clone button 2812 associated with each sample. Selection of sample clone button 2812 creates a copy of the sample row associated with sample clone button 2812.

First experiment interface window 2800 further may include a sample delete button 2814 associated with each sample in sample table 2802. When an indicator is received indicating selection of sample delete button 2814, the associated sample is deleted and the associated row removed from sample table 2802.

First experiment interface window 2800 further may include an add sample button 2816, a number of samples text window 2818, and an import sample from file button 2820. A desired number of samples may be entered by the user in number of samples text window 2818. Selection of add sample button 2816 adds the specified number of samples to sample table 2802. Unique sample names starting with “Sample 001” are added to sample table 2802 automatically.

Selection of import sample from file button 2820 allows the user to import sample data from a file that is selected by the user. The file may be stored, for example, in computer-readable medium 708. With reference to FIG. 29, a mapping user interface 2900 may be presented in accordance with an illustrative embodiment to allow the user to map columns of data in the selected file to the columns in sample table 2802. The selected file may be a tab delimited text file or a comma delimited file such as a .csv file with the samples organized in rows. The first row may include a table header that includes column names.

Mapping user interface 2900 may include a first column selector 2902, a second column selector 2904, and a third column selector 2906. Selection of first column selector 2902, second column selector 2904, and third column selector 2906 results in presentation of a plurality of column selectors 2908. The plurality of column selectors 2908 may include a list of the column headers included in the selected file. The user selects the header associated with the column in the selected file that maps to each column of sample table 2802. Data associated with columns that are not selected is not imported.

With continuing reference to FIG. 27, in an operation 2706, sample information is received. For example, the user may select a next button presented in first experiment interface window 2800, which results in saving the sample information from first experiment interface window 2800, and in presentation of a second experiment interface window 3000 shown with reference to FIG. 30 in accordance with an illustrative embodiment. Second experiment interface window 3000 may include experiment status indicator bar 2602 updated to reflect the current workflow status.

Second experiment interface window 3000 further may include a sample analysis table 3002. Sample analysis table 3002 may include a plurality of sample analysis rows 3004 with one or more analysis rows defined for each sample defined for the experiment. If the selected analysis contains controls, the controls may be automatically added below the associated sample. Sample analysis table 3002 may include a plurality of columns of information for each row of the plurality of sample analysis rows 3004. For example, sample analysis table 3002 may include a sample selector column 3006 and a sample identifier column 3008 associated with each row of the plurality of sample analysis rows 3004. Sample selector column 3006 may only be selectable for each sample. For example, a first sample selector 3010 associated with “Sample 001” may be “active”; whereas, a second sample selector 3012 associated with a control “NCE1|BN” of “Sample 001” may be “inactive”. Sample name column 2806 includes a unique descriptive name for the sample/control. A header of sample selector column 3006 may include a sample selector.

Second experiment interface window 3000 further may include a sample delete button 3014, a first unassign analysis button 3016, and a second unassign analysis button 3018. Sample delete button 3014 and first unassign analysis button 3016 may be associated with each sample in sample analysis table 3002. Second unassign analysis button 3018 may be associated with each analysis. When an indicator is received indicating selection of sample delete button 3014, the associated sample is deleted and the associated rows removed from sample analysis table 3002. When an indicator is received indicating selection of first unassign analysis button 3016, the associated analysis is unassigned for the sample. When an indicator is received indicating selection of second unassign analysis button 3018, the associated analysis is unassigned for all samples at once.

Second experiment interface window 3000 further may include a plate fill indicator 3020. Plate fill indicator 3020 indicates the amount (%) of used space on the qPCR plate. When the number of used wells exceeds the number of free wells on the plate, certain samples or analyses may be excluded from the experiment. If space remains on the plate, additional samples may be added by returning to first experiment interface window 2800 and adding new samples and/or additional analyses can be assigned to some or all of the samples.

To assign extra analyses to a sample, a selection of samples, or to all of the samples on the plate, the desired samples may be selected using the associated selectors of sample selector column 3006. For example, to add analyses to the first sample, first sample selector 3010 is checked and an assign analysis button 3022 is selected. To add analyses to all samples listed in sample analysis table 3002, sample selector column 3006 is checked and assign analysis button 3022 is selected.

When an indicator is received indicating selection of assign analysis button 3022, an analysis selection interface window 3100 shown with reference to FIG. 31, in accordance with an illustrative embodiment, is presented. Analysis selection interface window 3100 may include an analysis list 3102, a search window 3104, and a search button 3106. The user may enter search text in search window 3104, for example, using keyboard 716 and select search button 3106 to search for the search text in qPCR analysis name column 1506. Using search button 3106, the user can quickly locate a qPCR analysis to assign to the sample. In an illustrative embodiment, only analyses compatible with a first analysis assigned to a plate/experiment may be listed in analysis list 3102. Compatible analyses may be determined based on a comparison of various analysis fields. For example, compatible analyses may be those that have the same values entered in qPCR cycler manufacturer selector 1718, qPCR cycler model selector 1720, qPCR cycler software version number selector 1722, qPCR cycler plate size selector 1724, and reaction volume window 1726.

With continuing reference to FIG. 27, in an operation 2708, analyses information is received. For example, the user may select a next button presented in second experiment interface window 3000, which results in saving the sample analyses information from second experiment interface window 3000, and in presentation of a third experiment interface window 3200 shown with reference to FIG. 32 in accordance with an illustrative embodiment. Third experiment interface window 3200 may include experiment status indicator bar 2602 updated to reflect the current workflow status.

Third experiment interface window 3200 further may include a qPCR plate identifier 3202, a sample dilutions identifier 3204, and a master mixes identifier 3206. qPCR plate identifier 3202 is included if qPCR plate check box 2616 is checked. Sample dilutions identifier 3204 is included if sample dilutions check box 2618 is checked. Master mixes identifier 3206 is included if master mixes check box 2620 is checked. Whether qPCR plate identifier 3202, sample dilutions identifier 3204, and master mixes identifier 3206 are not filled, partially filled, or fully filled may indicate whether or not a bed layout definition for that work bed is not started, in process, or complete, respectively. As an example, qPCR plate identifier 3202 is partially filled in experiment interface window 3200 because the bed layout definition for the qPCR work bed is in process. Sample dilutions identifier 3204 and master mixes identifier 3206 are not filled because the bed layout definition for those work beds is not started.

Third experiment interface window 3200 further may include a plurality of plate positions. For example, third experiment interface window 3200 includes a 3×3 grid of nine plate positions because it is associated with rack plate 234. For example, first cavity 400 is associated with a first plate position 3208; second cavity 402 is associated with a second plate position 3210; third cavity 404 is associated with a third plate position 3212; fourth cavity 406 is associated with a fourth plate position 3214; fifth cavity 408 is associated with a fifth plate position 3216; sixth cavity 410 is associated with a sixth plate position 3218; seventh cavity 412 is associated with a seventh plate position 3220; eighth cavity 414 is associated with a eighth plate position 3222; and ninth cavity 416 is associated with a ninth plate position 3224.

In the illustrative embodiment of FIG. 32, first plate position 3208 may be associated with a tip waste rack by default. Second plate position 3210 and third plate position 3212 may be associated with tip racks by default. Fourth plate position 3214, fifth plate position 3216, and sixth plate position 3218 may be associated with sample racks by default. Seventh plate position 3220 may be associated with a qPCR plate by default. Eighth plate position 3222 and ninth plate position 3224 may be associated with master mix plates by default.

One or more of the plate positions may include a selector that allows the user to select a labware component for the plate position. For example, fourth plate position 3214 may include a sample plate selector 3226, seventh plate position 3220 may include a qPCR plate selector 3228, and eighth plate position 3222 may include a mix plate selector 3230. When selected the selectors 3226, 3228, 3230 include an appropriate list of labware components selected from labware table 1108. For example, the labware components listed may be selected based on an entry in labware name column 1112 and/or in holder type column 1114 of labware table 1108 based on the plate position. By default, the most suitable labware component for each plate position may be selected though the labware component can be changed using the selectors 3226, 3228, 3230. The most suitable labware component is selected by taking into account protocol parameters such as, but not limited to, reaction volume, sample volume, number of samples, number of sample dilutions, etc. in order to decrease the time required for the liquid handler to execute the protocol.

Third experiment interface window 3200 further may include a multidispense check box 3232 and a tip check box 3234. Selection of multidispense check box 3232 allows a multidispense for master mixes making the protocol more time efficient. A larger volume of master mix is aspirated into a tip of pipetting heads 212 and is dispensed in several aliquots to the qPCR plate mounted in seventh plate position 3220. Since the master mix is pipetted into the qPCR plate first, there is no concern about cross-contamination.

Selection of tip check box 3234 allows use of the same tip for master mix replicate transfers, which reduces the number of tips used during loading of the master mixes onto the qPCR plate when multidispense check box 3232 is not checked. Tips are changed only after each transfer group (e.g. after each master mix) instead of changing tips after every transfer.

A fourth experiment interface window 3300 is shown with reference to FIG. 33 in accordance with an illustrative embodiment for a sample dilutions bed layout. Fourth experiment interface window 3300 may include experiment status indicator bar 2602 updated to reflect the current workflow status. Fourth experiment interface window 3300 further may include qPCR plate identifier 3202, sample dilutions identifier 3204, and master mixes identifier 3206 updated such that qPCR plate identifier 3202 is filled because the bed layout definition for the qPCR work bed is complete. Sample dilutions identifier 3204 is partially filled because the bed layout definition for the sample dilutions work bed is in process. Master mixes identifier 3206 is not filled because the bed layout definition for the master mixes work bed is not started.

Fourth experiment interface window 3300 further may include first plate position 3208, second plate position 3210, third plate position 3212, fourth plate position 3214, fifth plate position 3216, sixth plate position 3218, seventh plate position 3220, eighth plate position 3222, ninth plate position 3224, multidispense check box 3232, and tip check box 3234. In the illustrative embodiment of FIG. 33, first plate position 3208 may be associated with a tip waste rack by default. Second plate position 3210 and third plate position 3212 may be associated with tip racks by default. Fourth plate position 3214 may be associated with a water source plate by default. Fifth plate position 3216 and sixth plate position 3218 may be associated with sample source racks by default. Seventh plate position 3220, eighth plate position 3222, and ninth plate position 3224 may be associated with sample dilution plates by default.

One or more of the plate positions may include a selector that allows the user to select a labware component for the plate position. For example, fourth plate position 3214 may include a water source selector 3302, and fifth plate position 3216 may include a sample plate selector 3304. When selected the selectors 3302, 3304 include an appropriate list of labware components selected from labware table 1108. By default, the most suitable labware component for each plate position may be selected though the labware component can be changed using the selectors 3302, 3304.

A fifth experiment interface window 3400 is shown with reference to FIG. 34 in accordance with an illustrative embodiment for a master mixes bed layout. Fifth experiment interface window 3400 may include experiment status indicator bar 2602 updated to reflect the current workflow status. qPCR plate identifier 3202 and sample dilutions identifier 3204 are filled because the bed layout definition for the qPCR work bed and sample dilutions work bed is complete. Master mixes identifier 3206 is partially filled because the bed layout definition for the master mixes work bed is in process.

Fifth experiment interface window 3400 further may include first plate position 3208, second plate position 3210, third plate position 3212, fourth plate position 3214, fifth plate position 3216, sixth plate position 3218, seventh plate position 3220, eighth plate position 3222, ninth plate position 3224, and tip check box 3234. In the illustrative embodiment of FIG. 34, first plate position 3208 may be associated with a tip waste rack by default. Second plate position 3210 and third plate position 3212 may be associated with tip racks by default. Fourth plate position 3214 and fifth plate position 3216 and sixth plate position 3218 may be associated with master mix racks by default. Sixth plate position 3128, seventh plate position 3220, eighth plate position 3222, and ninth plate position 3224 may be associated with reagent source plates by default.

One or more of the plate positions may include a selector that allows the user to select a labware component for the plate position. For example, ninth plate position 3224 may include a reagent source selector 3402. When selected, reagent source selector 3402 includes an appropriate list of labware components 3404 selected from labware table 1108. By default, the most suitable labware component for each plate position may be selected though the labware component can be changed using reagent source selector 3402.

With continuing reference to FIG. 27, in an operation 2710, bed layout information is received. For example, the user may select a next button presented in second experiment interface window 3000, third experiment interface window 3200, fourth experiment interface window 3300, fifth experiment interface window 3400, which results in saving the bed layout information, and in presentation of a sixth experiment interface window 3500 shown with reference to FIG. 35 in accordance with an illustrative embodiment. Sixth experiment interface window 3500 may include experiment status indicator bar 2602 updated to reflect the current workflow status.

Sixth experiment interface window 3500 may include experiment status indicator bar 2602 updated to reflect the current workflow status. Sixth experiment interface window 3500 further may include a plurality of outputs that may be generated by the user. In the illustrative embodiment, the outputs may be of two types: 1) files, such as print-ready PDF files, and 2) protocols ready for execution by controller 600 of liquid handler 200. For example, sixth experiment interface window 3500 includes a first button 3502, a second button 3504, a third button 3506, a fourth button 3510, a fifth button 3512, and a sixth button 3514 selection of which triggers opening of a PDF or text file.

Selection of first button 3502 opens a first PDF file that describes the manual preparation of master mixes used in the experiment. Each table in the first PDF file shows the concentrations and volumes of reagents for manual preparation of the master mix for one assay.

Selection of second button 3504 opens a second PDF file that describes the manual preparation of sample dilutions. The second PDF file contains recipes for manual preparation of serial dilutions for each sample in the experiment. For example, the second PDF file includes a table with a sample name column, a dilution column, a sample volume column, a water volume column, and a final sample volume column. The sample name column includes sample names of samples and control samples in the experiment excluding NTC controls, which is water. The dilution column includes dilution factors. Extra dilution steps added automatically may be written in a different color than required dilutions for the experiment and can be discarded after all the dilutions have been made. The sample volume column includes a carry over sample volume from a previous dilution that may be added to the water to obtain the desired dilution factor. The water volume column includes a volume of water into which the carry over sample may be added. The final sample volume column includes the final volume of each sample dilution after preparing all of the dilutions.

Selection of third button 3506 opens a text file(s) that describes the template for the qPCR Cycler. The text file(s) contain the information for automatic setting-up of a qPCR run on a qPCR Cycler to avoid manual re-entering of the information into the cycler. The qPCR template file can be directly imported into the qPCR Cycler. The qPCR template may contain the following data: qPCR plate format, sample positions on qPCR plate and sample names, information about reporters and their position, sample type information (e.g. unknown, NTC, . . . ), and information on single/multiplex run.

Selection of fourth button 3510, fifth button 3512, and sixth button 3514 open PDF files that describe a pipetting guide for liquid handler 200 to prepare the qPCR plate, the master mixes, and the sample dilutions, respectively. Each of the pipetting guides contains a bed layout description with a list and positions of labware and positions and volumes of samples/reagents/master sixes. For example, a qPCR plate pipetting guide includes the setup of work bed 206 of liquid handler 200. The qPCR plate pipetting guide may contain: information about the current experiment (experiment name and date), labware specifications and position on work bed 206, detailed schemes of labware containing master mixes, detailed schemes of labware containing sample dilutions, detailed scheme of labware containing qPCR plate, etc.

A master mix plate pipetting guide includes the setup of work bed 206 of liquid handler 200 with each of the wells containing the following information: assay name, volume of the master mix, and a color code selected for that particular assay using master mix color selector 2224. The volume is calculated automatically and includes the extra volume specified in extra volume window 1728.

A sample dilutions plate pipetting guide includes the setup of work bed 206 of liquid handler 200 with each of the wells containing the following information: sample name, volume of the sample, and dilution of the sample. The volume is calculated automatically and includes the extra volume specified in extra volume window 1728. Samples in the sample dilution plate are organized for optimal multichannel transfers to the target plate to reduce pipetting time. If using a 96 well plate for a sample dilutions source plate and a 384 well target qPCR Plate, every second sample in the column of 384 qPCR plate is placed together in the column of 96 sample dilutions plate to enable optimal multichannel transfers to the 384 plate saving additional pipetting time. The same sample may be positioned in more than one well on the sample source plate when the volume of sample exceeds the maximum volume of one well (defined in the specification for each labware).

An eighth button 3516, a ninth button 3518, and a tenth button 3520 trigger generation and opening of a file that includes the pipetting protocols ready for execution by liquid handler 200 for preparing the qPCR plate, the master mixes, and/or the sample dilutions, respectively. Each pipetting protocol (plate pipetting protocol and/or a sample dilutions pipetting protocol and/or master mixes pipetting protocol) contains a plurality of instructions configured to cause the liquid handler to automatically control the aspiration/dispensation of material into/out of the sample receptacles according to the information entered by the user during interaction with the one or more user interface windows presented under control of protocol creation application 712 and/or second protocol creation application 810.

Independent of which of the three protocols are selected to be generated by the user a first step in protocol generation is creation of a virtual qPCR plate. The virtual qPCR plate consists of a grid of wells, the number of wells and the contents of which are determined by a combination of the analyses created in the analysis creation workflow (qPCR analysis interface windows), the samples (and thereby isolation codes) assigned to each analysis in the experiment user interface windows and the labware selected for the qPCR plate from the experiment user interface windows. The wells are ordered to support easy collection and interpretation of the qPCR results for the user and to make it more likely for liquid handler 200 to be able to perform as many multichannel transfers as possible, thus reducing the time required for liquid handler 200 to execute the protocol. The order that the wells are aspirated from or dispensed into can be altered by the user though a more time consuming protocol results. The virtual qPCR plate is generated when the user moves from second experiment interface window 3000 to third experiment interface window 3200 in the in the experiment user interface and represents the basis of all three protocols (plate pipetting protocol, sample dilutions pipetting protocol, master mixes pipetting protocol) independently of which protocols are generated.

The qPCR plate pipetting protocol is responsible for transferring sample dilutions and master mixes from labware containing sample dilutions and labware containing master mixes, respectively, to the qPCR plate. The volumes, dilutions and composition of both are determined by the user in qPCR analysis interface windows of the analysis (or several analyses), which are used in the current experiment being entered by the user in experiment user interface windows.

The labware containing sample dilutions is created in the protocol (on one or more positions on the bed), which contains enough wells to host all dilutions of all samples (each combination of sample and dilution factor) also taking into account the volumes required to fill qPCR plate wells and the maximum and ‘dead’ volumes of the labware containing sample dilution plate. The positioning of the wells on the labware is designed to mimic their positioning on the qPCR plate, thereby allowing the use of multichannel transfers between the plates by liquid handler 200 and reducing the time required to execute the protocol.

The labware containing master mixes is created in the protocol (on one or more positions on the bed). Labware contains wells that contain master mixes in sufficient volumes to fill the qPCR plate wells. Labware containing master mix plate(s) is created in such a way that protocol creation application 712 and/or second protocol creation application 810 take into account the list of wells on the qPCR plate that contain a particular type of master mix and adding up the volumes of master mixes needed. These volumes are distributed into one or more wells on the labware based on the physical properties of the labware selected by the user.

Protocol creation application 712 and/or second protocol creation application 810 creates a list of transfers needed to transfer the required volumes from labware containing the master mixes and labware containing the sample dilutions to the qPCR plate. The master mix transfers may be grouped into aliquot transfers, depending on whether or not the user selected this option. The sample dilution protocols are ordered in a way to maximize the number of multichannel transfers performed by liquid handler 200 reducing the time required to execute the protocol. In an illustrative embodiment, the list of transfers, labware, and well contents are packaged into SQLite files, which can be used to instruct liquid handler 200 to perform the protocol(s).

The master mix pipetting protocol is, in most cases, the simplest of the three protocols. The master mix pipetting protocol combines and mixes the required quantities of reagents to produce the required volumes of master mixes required for the labware containing the master mix plate. These volumes and their positions are imported from the qPCR protocol. To help reduce errors, this protocol (in cases where a single master mix needs to be contained in multiple wells), mixes equal quantities of the master mix in each well before redistributing it in accordance with the volume distribution determined by the qPCR protocol. Just like the qPCR protocol, this protocol also creates a list of transfers required to perform the master mixing as defined by the user. In an illustrative embodiment, the master mixing process is not optimized for speed because the master mix reagents are commonly too valuable for their volumes to be wasted when performing multichannel transfers. The list of transfers, labware and plate contents are packaged and used in the same way as those contained in the qPCR protocol.

The sample dilutions protocol is, in most cases the most complex of the three protocols. The sample dilutions protocol is responsible for preparing the labware containing the sample dilutions plate(s) needed by the qPCR protocol. In the protocol up to three types of labware may be created: labware containing sample sources, labware containing water, and labware containing sample dilution plate(s).

To generate the sample dilutions protocol, a list of dilutions and a list of wells that belong to each dilution in the labware containing sample dilutions plate(s) created by the qPCR protocol are created. A tree of dilutions may be created with each node of the tree representing a dilution. The children of each node represent the dilutions created from the parent node. The root of this tree contains the undiluted samples. The leaves of the tree contain the dilutions that are not used to make other dilutions. Once the tree is created, protocol creation application 712 and/or second protocol creation application 810 goes through each node and adds appropriate volumes to create the sample dilutions associated with the node to the sample dilutions associated with the parent node, as well as water volumes needed to dilute the sample volumes to the required level. The volumes determined in this way are assigned to appropriate wells on the labware containing sample dilutions plate(s). If no appropriate wells exist, new wells are created. Wells containing undiluted samples are placed on the labware containing sample source plate(s). The water is distributed into wells on the labware containing water source plate. Protocol creation application 712 and/or second protocol creation application 810 creates the list of transfers needed to move the volumes that are calculated in the previous steps, beginning with the water transfers. Once they are done, the sample transfers are created, ordered from the lowest dilution to the highest and grouped appropriately to maximize the chance of multichannel transfers, reducing the time for the execution of the protocol by liquid handler 200. In an illustrative embodiment, the transfers, labware and labware contents are packaged into SQLite files used by liquid handler 200.

The PDF files created when an indicator indicates selection of fourth button 3510, fifth button 3512, or sixth button 3514 contain a short, easily readable summary of the labware and well contents of each of the protocols created by protocol creation application 712 and/or second protocol creation application 810 and are created by directly reading the information from the protocols stored, for example, in database 714 and/or second database 812 before being packaged into the SQLite files. This information is combined with extra information about the analyses used in the experiment to provide a more user-friendly overview of the contents of the various plates and the information required to prepare those contents by hand should the user so desire.

Selection of a seventh button 3508 opens the pipetting guide for liquid handler 200 to prepare the qPCR plate for editing. The qPCR plate can be edited by moving (swapping) one well or a group of wells. For example, the user may select seventh button 3508, which results in presentation of a seventh experiment interface window 3600 shown with reference to FIG. 36 in accordance with an illustrative embodiment. Seventh experiment interface window 3600 may include a grid of wells 3602, a swap button 3604, a discard changes button 3606, a confirm button 3608, a source wells check box 3610, and a target wells check box 3612.

To swap one well, a source well may be selected from the grid of wells 3602 by tapping twice on it and the target well may be selected from the grid of wells 3602 by tapping once on it. Selection of swap button 3604 swaps the selected wells.

To swap a group of wells, a group of wells may be selected from the grid of wells 3602 by tapping on a top left corner of the group and then tapping on a bottom right corner of the group creating a rectangle. The selected wells may be highlighted with a distinguishing color. The target position may be selected by tapping a well on a top left corner of the destination rectangle. Selection of swap button 3604 swaps the selected group of wells.

A type of selection can be changed from source to target or vice versa by selecting source wells check box 3610 and/or target wells check box 3612. Selection of discard changes button 3606 discard changes. Selection of confirm button 3608 saves the changes. The calculations in all output files are updated automatically.

With continuing reference to FIG. 27, in an operation 2712, output information is created. For example, the user may select a next button presented in sixth experiment interface window 3500, which results in creating and saving the output information from sixth experiment interface window 3500. For example, the output information may be stored in computer-readable medium 708 as a file(s) and/or in database 714.

A variety of different types of user interface controls may be included in the described user interface windows without limitation such as buttons, drop down menus, tabs, shortcut keys, toolbars, radio buttons, check boxes, etc. as known to a person of skill in the art to allow a user to enter information into and/or make selections from a user interface. Those shown herein are merely representative of the controls which can be used to provide the described functionality.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” is intended to include “and/or” unless specifically indicated otherwise. The illustrative embodiments may be implemented as a method, apparatus, or article of manufacture using standard programming and/or engineering techniques to produce software, firmware, hardware, or any combination thereof to control a computer to implement the disclosed embodiments.

The foregoing description of illustrative embodiments of the disclosed subject matter has been presented for purposes of illustration and of description. It is not intended to be exhaustive or to limit the disclosed subject matter to the precise form disclosed, and modifications and variations are possible in light of the above teachings or may be acquired from practice of the disclosed subject matter. The embodiments were chosen and described in order to explain the principles of the disclosed subject matter and as practical applications of the disclosed subject matter to enable one skilled in the art to utilize the disclosed subject matter in various embodiments and with various modifications as suited to the particular use contemplated. It is intended that the scope of the disclosed subject matter be defined by the claims appended hereto and their equivalents.

1. A non-transitory computer-readable medium having stored thereon computer-readable instructions that when executed by a computing device cause the computing device to:
control presentation of a sample definition interface window on a display;
receive a first indicator from the sample definition interface window, wherein the first indicator identifies selection of a first sample to which to assign a first analysis;
control presentation of a first analysis selection interface window on the display in response to the selection of the first sample, wherein the first analysis selection interface window includes a first plurality of analyses;
receive a second indicator from the first analysis selection interface window, wherein the second indicator indicates selection of the first analysis from the first plurality of analyses, wherein the first analysis defines processing to be performed on the identified first sample by a liquid handler to create a quantitative polymerase chain reaction plate, a sample dilutions plate, and a master mixes plate;
receive a third indicator from the sample definition interface window, wherein the third indicator identifies selection of the first sample to which to assign a second analysis;
determine a second plurality of analyses from the first plurality of analyses, wherein the second plurality of analyses is a subset of the first plurality of analyses that is compatible with the selected first analysis;
control presentation of a second analysis selection interface window on the display, wherein the second analysis selection interface window includes the determined second plurality of analyses;
receive a fourth indicator from the second analysis selection interface window, wherein the fourth indicator indicates selection of the second analysis from the determined second plurality of analyses, wherein the second analysis defines second processing to be performed on the identified first sample by the liquid handler, wherein the first analysis is different from and independent of the second analysis;
determine a bed layout for the liquid handler based on the first indicator, the second indicator, and the fourth indicator, wherein the bed layout defines locations of a plurality of labware components and a type of labware component at each location on a work bed of the liquid handler to perform the first analysis and the second analysis on the selected first sample, wherein the selected first sample is associated with a labware component of the plurality of labware components;
control presentation of the determined bed layout on the display; and
create a protocol for execution by a controller of the liquid handler, wherein the protocol comprises a second plurality of instructions configured to cause the liquid handler to perform the first analysis and the second analysis on the selected first sample based on the determined bed layout.

2. The computer-readable medium of claim 1, wherein the first indicator comprises a sample name and a sample extraction code.

3. The computer-readable medium of claim 1, wherein the first indicator further identifies a second sample that is different from the first sample.

4. The computer-readable medium of claim 3, wherein the second indicator further indicates a third analysis for the second sample wherein the third analysis is different from the first analysis and from the second analysis.

5. (canceled)

6. (canceled)

7. (canceled)

8. (canceled)

9. The computer-readable medium of claim 1, wherein the sample definition interface window includes a plate fill indicator, wherein the plate fill indicator indicates a percentage of the associated labware component of the plurality of labware components used by the first sample and the second sample to perform the first analysis and the second analysis.

10. The computer-readable medium of claim 1, wherein the computer-readable instructions further cause the computing device to determine a control sample created based on the second indicator, wherein the control sample is included in the presented bed layout.

11. The computer-readable medium of claim 1, wherein at least one location of the locations includes a selector, wherein the selector indicates a default type of labware component to position in at least one location of the locations and the selector is configured to present a list of additional types of labware components that can be positioned in the at least one location of the locations based on the first indicator, the second indicator, and the fourth indicator.

12. The computer-readable medium of claim 1, wherein the computer-readable instructions further cause the computing device to receive a fifth indicator, wherein the fifth indicator identifies a type of protocol to create, wherein the protocol is further created based on the fifth indicator.

13. The computer-readable medium of claim 12, wherein the type of protocol is selected from the group consisting of a quantitative polymerase chain reaction plate pipetting protocol, a sample dilutions pipetting protocol, and a master mixes pipetting protocol.

14. The computer-readable medium of claim 1, wherein the computer-readable instructions further cause the computing device to receive a fifth indicator, wherein the fifth indicator identifies a plurality of types of protocols to create, wherein a protocol is created for each of the plurality of types of protocols.

15. The computer-readable medium of claim 14, wherein a bed layout is determined for each of the plurality of types of protocols.

16. The computer-readable medium of claim 15, wherein the bed layout for each of the plurality of types of protocols is presented on the display.

17. The computer-readable medium of claim 1, wherein the first analysis and the second analysis are predefined by a user and each include specification of a number of replicates of the first sample and a dilution of the first sample for performing the first analysis and the second analysis on the selected first sample.

18. The computer-readable medium of claim 1, wherein the computer-readable instructions further cause the computing device to receive specifications of a plurality of different types of labware components based on a user selection from a user interface window, wherein determining the bed layout is further based on the received specifications.

19. (canceled)

20. (canceled)

21. A system comprising:
a processor;
a display operably coupled to the processor; and
a non-transitory computer-readable medium operably coupled to the processor, the computer-readable medium having computer-readable instructions stored thereon that, when executed by the processor, cause the system to
control presentation of a sample definition interface window on the display;
receive a first indicator from the sample definition interface window, wherein the first indicator identifies selection of a first sample to which to assign a first analysis;
control presentation of a first analysis selection interface window on the display in response to the selection of the first sample, wherein the first analysis selection interface window includes a first plurality of analyses;
receive a second indicator from the first analysis selection interface window, wherein the second indicator indicates selection of the first analysis from the first plurality of analyses, wherein the first analysis defines processing to be performed on the identified first sample by a liquid handler to create a quantitative polymerase chain reaction plate, a sample dilutions plate, and a master mixes plate;
receive a third indicator from the sample definition interface window, wherein the third indicator identifies selection of the first sample to which to assign a second analysis;
determine a second plurality of analyses from the first plurality of analyses, wherein the second plurality of analyses is a subset of the first plurality of analyses that is compatible with the selected first analysis;
control presentation of a second analysis selection interface window on the display, wherein the second analysis selection interface window includes the determined second plurality of analyses;
receive a fourth indicator from the second analysis selection interface window, wherein the fourth indicator indicates selection of the second analysis from the determined second plurality of analyses, wherein the second analysis defines second processing to be performed on the identified first sample by the liquid handler, wherein the first analysis is different from and independent of the second analysis;
determine a bed layout for the liquid handler based on the first indicator, the second indicator, and the fourth indicator, wherein the bed layout defines locations of a plurality of labware components and a type of labware component at each location on a work bed of the liquid handler to perform the first analysis and the second analysis on the selected first sample, wherein the selected first sample is associated with a labware component of the plurality of labware components;
control presentation of the determined bed layout on the display; and
create a protocol for execution by a controller of the liquid handler, wherein the protocol comprises a second plurality of instructions configured to cause the liquid handler to perform the first analysis and the second analysis on the selected first sample based on the determined bed layout.

22. A method of creating a protocol, the method comprising:
presenting a sample definition interface window on a display;
receiving, at a first device, a first indicator from the sample definition interface window, wherein the first indicator identifies selection of a first sample to which to assign a first analysis;
presenting a first analysis selection interface window on the display in response to the selection of the first sample, wherein the first analysis selection interface window includes a first plurality of analyses;
receiving, at the first device, a second indicator from the first analysis selection interface window, wherein the second indicator indicates selection of the first analysis from the first plurality of analyses, wherein the first analysis defines processing to be performed on the identified first sample by a liquid handler to create a quantitative polymerase chain reaction plate, a sample dilutions plate, and a master mixes plate;
receiving, at the first device, a third indicator from the sample definition interface window, wherein the third indicator identifies selection of the first sample to which to assign a second analysis;
determining, by the first device, a second plurality of analyses from the first plurality of analyses, wherein the second plurality of analyses is a subset of the first plurality of analyses that is compatible with the selected first analysis;
presenting a second analysis selection interface window on the display, wherein the second analysis selection interface window includes the determined second plurality of analyses;
receiving, at the first device, a fourth indicator from the second analysis selection interface window, wherein the fourth indicator indicates selection of the second analysis from the determined second plurality of analyses, wherein the second analysis defines second processing to be performed on the identified first sample by the liquid handler, wherein the first analysis is different from and independent of the second analysis;
determining, by the first device, a bed layout for the liquid handler based on the first indicator, the second indicator, and the fourth indicator, wherein the bed layout defines locations of a plurality of labware components and a type of labware component at each location on a work bed of the liquid handler to perform the first analysis and the second analysis on the selected first sample, wherein the selected first sample is associated with a labware component of the plurality of labware components;
presenting the determined bed layout on the display; and
creating, by the first device, a protocol for execution by a controller of the liquid handler, wherein the protocol comprises a second plurality of instructions configured to cause the liquid handler to perform the first analysis and the second analysis on the selected first sample based on the determined bed layout.

23. The computer-readable medium of claim 16, wherein at least one location of the locations presented on the bed layout for at least one protocol of the plurality of types of protocols includes a selector, wherein the selector indicates a default type of labware component to position in the at least one location of the locations and the selector is configured to present a list of additional types of labware components that can be positioned in the at least one location of the locations based on the first indicator, the second indicator, the fourth indicator, and the at least one protocol.

24. The computer-readable medium of claim 23, wherein the computer-readable instructions further cause the computing device to receive a selection selected using the selector from the list of additional types of labware components; and to revise the bed layout for another protocol of the plurality of types of protocols based on the received selection.

25. The computer-readable medium of claim 1, wherein the computer-readable instructions further cause the computing device to determine a well layout for the associated labware component based on the first indicator, the second indicator, and the fourth indicator, wherein the well layout defines a well location of the first sample, wherein the protocol is further created based on the determined well layout.

26. The computer-readable medium of claim 25, wherein the determined well layout maximizes a number of multichannel transfers performed by the liquid handler in conducting the first analysis and the second analysis.

27. The computer-readable medium of claim 14, wherein the computer-readable instructions further cause the computing device to:
determine a well layout for each protocol of the plurality of types of protocols;
receive a sixth indicator indicating a change to a well layout determined for one of the protocols of the plurality of types of protocols; and
revise the determined well layout for each remaining protocol of the plurality of types of protocols based on the sixth indicator.

28. The computer-readable medium of claim 18, wherein the specifications received for each labware component of the plurality of different types of labware components include a labware component type identifier, a number of receptacles, and a volume capacity of each receptacle of the receptacles.
